(19) United States
(12) Patent Application Publication
(10) Pub. No.: US 2010/0032866 A1
(43) Pub. Date: Feb. 11, 2010

(54) METHOD FOR PRODUCING THERMOPLASTIC RESIN FILM

(75) Inventors: Shinichi Nakai, Shizuoka (JP); Kiyokazu Hashimoto, Kanagawa (JP); Zemin Shi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/916,574

(22) PCT Filed: Jun. 6, 2006
(86) PCT No.: PCT/JP2006/311703

§ 371 Date: Dec. 5, 2007

(30) Foreign Application Priority Data
Jun. 7, 2005 (JP) 2005-166984

(51) Int. Cl. B29C 55/02; B29C 71/02

(52) U.S. Cl. 264/291; 264/345

(57) ABSTRACT

There is provided a method for producing a thermoplastic resin film that can suppress the occurrence of color nonuniformity in the produced thermoplastic resin film even when the film is incorporated into liquid crystal display devices and exposed to high temperature and high humidity over time. Heat treatment is conducted for the thermoplastic resin film at a temperature of Tg−30° C. or higher and Tg+20° C. or lower, Tg representing the glass transition temperature of the thermoplastic resin, for 10 seconds to 600 seconds while conveying the thermoplastic resin film at a tension of 2 N/cm² to 120 N/cm².

### TECHNICAL FIELD

The present invention relates to a method for producing a thermoplastic resin film, particularly to a method for producing a thermoplastic resin film, such as a saturated norbornene film, used for liquid crystal displays.

### BACKGROUND ART

Methods for producing a thermoplastic resin film is broadly classified into two major categories: solution film forming method; and melt film forming method. The solution film forming method is a method in which a dope of a thermoplastic resin in a solvent is cast from a die onto a support, for example, a cooling drum so that it is formed into a film, while the melt film forming method is a method in which a thermoplastic resin is melted in an extruder and extruded from a die onto a support, for example, a cooling drum so that it is formed into a film. Thermoplastic resin films formed by these methods are usually stretched longitudinally (across the length) and transversely (across the width) so that they develop in-plane retardation (Re) and retardation in the thickness direction (Rth), and attempts have been made to use such stretched films as a retardation film for liquid crystal display devices to realize a wider viewing angle in liquid crystal displays (see, for example, National Publication of International Patent Application No. 6-501040 and Japanese Patent Laid-Open No. 2001-42130).

### DISCLOSURE OF THE INVENTION

Thermoplastic resin films formed by conventional production method including both the solution film-forming method and the melt film-forming method have problems that they tend to show shrinkage when exposed to high temperature and high humidity environments (hereinafter referred to as “heat shrinkage”). When the film is incorporated in a liquid crystal display element, the heat shrinkage tends to cause phenomena such as leakage of light from a corner of a liquid crystal display screen and color nonuniformity including shading. In particular, when the film is used as a high performance film for optical applications, the film which may generate the frame-like failure or color nonuniformity presents a problem.

Methods for suppressing generation of heat shrinkage may include selection of a thermoplastic resin which hardly undergoes heat shrinkage, optimization of temperature conditions for melting a thermoplastic resin and cooling the same and the like. However, these methods have involved problems that they cannot effectively suppress generation of heat shrinkage that adversely affects optical films.

The present invention has been accomplished under these circumstances and has as an object to provide a method for producing a thermoplastic resin film capable of producing a thermoplastic resin film which hardly undergoes heat shrinkage that causes frame-like failure and color nonuniformity, and to provide a thermoplastic resin film produced by the method.

According to a first aspect of the present invention, to attain the aforementioned object, there is provided a method for producing a thermoplastic resin film, comprising the step of heat-treating a thermoplastic resin film at a temperature of Tg−30° C. to Tg+20° C., Tg representing the glass transition temperature of the saturated norbornene resin, for 10 seconds to 600 seconds while conveying the thermoplastic resin film at a tension of 2 N/cm² to 120 N/cm².

The present inventors have intensively investigated to solve the above-mentioned problems, and as a result, it has been found that it is possible to reduce the degree of heat shrinkage of a thermoplastic resin film by heat-treating the film at a specific temperature for a specific period of time to effect heat treatment of the film in the film-conveying direction (hereinafter referred to as “MD direction”) while conveying the film at a low tension in a heat-treatment oven. That is, it has been found that only the degree of heat shrinkage can be reduced without substantially changing the values of in-plane retardation Re and the retardation in the thickness direction Rth by thermally relaxing the thermoplastic resin film.

According to the first aspect, heat treatment is performed at a temperature of Tg−30° C. to Tg+20° C., Tg representing the glass transition temperature of the thermoplastic resin, for 10 seconds to 600 seconds while conveying the thermoplastic resin film at a tension of 2 N/cm² to 120 N/cm². As a result, it is possible to produce a thermoplastic resin film which hardly undergoes heat shrinkage that causes frame-like failure and color nonuniformity. That is, since the thermoplastic resin film is conveyed at a tension of 2 N/cm² to 120 N/cm², it can be thermally relaxed in the MD direction while preventing the slack of the film during the conveyance. The tension for conveying the film needs to be in the range where the film can be relaxed in the MD direction without slacking during conveyance. The tension is generally in the range of 2 N/cm² to 120 N/cm², preferably in the range of 5 N/cm² to 100 N/cm², more preferably in the range of 8 N/cm² to 80 N/cm², and most preferably in the range of 10 N/cm² to 40 N/cm². When the temperature for heat treatment is too low, the film cannot be relaxed, and when the temperature is too high, the values of Re and Rth may be varied. Therefore, the temperature for the heat treatment is preferably in the range of Tg−30° C. to Tg+20° C., more preferably in the range of Tg−20° C. to Tg+15° C., more preferably in the range of Tg−10° C. to Tg+10° C., and most preferably in the range of Tg−5° C. to Tg+5° C., Tg representing the glass transition temperature of the thermoplastic resin. Regarding the period of time for the heat treatment, when it is too short, the heat treatment is not effective, and when it is too long, the values of Re and Rth may be reduced. Therefore, the period of time for the heat treatment is preferably in the range of 10 seconds to 600 seconds, more preferably in the range of 20 seconds to 450 seconds, more preferably in the range of 30 seconds to 300 seconds, and most preferably in the range of 40 seconds to 200 seconds. The present invention can be applied to the thermoplastic resin films produced by both the solution film-forming method and the melt film-forming method.

According to a second aspect of the present invention, there is provided the method for producing a thermoplastic resin film according to the first aspect, wherein the thermoplastic resin film has a dimensional change under wet heating (δL(w)) and a dimensional change under dry heating (δL(d)) of 0% to 0.5% each.

In the thermoplastic resin film produced in the present invention, both the dimensional change under wet heating (δL(w)) and the dimensional change under dry heating (δL(d)) may be the range of 0% to 0.3%. Here, the dimensional change under dry heating refers to a larger value of the dimensional change (δMD(d)) in the longitudinal direction (MD) and the dimensional change (δTD(d)) in the width direction (TD) before and after exposing the film to a dry atmosphere at 80° C. for 500 hours. Incidentally, “dry” refers to the condition where relative humidity is 10% or less. Moreover, the dimensional change under wet heating refers to a larger value of the dimensional change (δMD(w)) in the longitudinal direction (MD) and the dimensional change (δTD(w)) in the width direction (TD) before and after exposing the film to an atmosphere of 60° C. and 90% rh for 500 hours.

According to a third aspect of the present invention, there is provided the method for producing a thermoplastic resin film according to the first or second aspect, wherein the thermoplastic resin film has a change of in-plane retardation (Re) under wet heating (δRe(w)) of 0% to 10%, a change of in-plane retardation (Re) under dry heating (δRe(d)) of 0% to 10%, a change of retardation in the thickness direction (Rth) under wet heating (δRth(w)) of 0% to 10%, and a change of retardation in the thickness direction (Rth) under dry heating (δRth(d)) of 0% to 10%.

In the thermoplastic resin film produced in the present invention, all of the change of in-plane retardation (Re) under wet heating (δRe(w)), the change of in-plane retardation (Re) under dry heating (δRe(d)), the change of retardation in the thickness direction (Rth) under wet heating (δRth(w)), and the change of retardation in the thickness direction (Rth) under dry heating (δRth(d)) may be the range of 0% to 10%. Here, the change of retardation under wet heating and the change of retardation under dry heating refer to the change of retardation under the above described test conditions, respectively.

According to a fourth aspect of the present invention, there is provided the method for producing a thermoplastic resin film according to any one of the first to third aspects, wherein the thermoplastic resin film has an orientation angle of 0°±5°, or 90°±5°; a bowing distortion of 10% or less; an in-plane retardation (Re) of 0 nm to 500 nm; and a retardation in the thickness direction (Rth) of 0 nm to 500 nm.

The thermoplastic resin film produced in the present invention may have an orientation angle of 0°±5°, or 90°±5°; a bowing distortion of 10% or less; an in-plane retardation (Re) of 0 nm to 500 nm; and a retardation in the thickness direction (Rth) of 0 nm to 500 nm.

According to a fifth aspect of the present invention, there is provided the method for producing a thermoplastic resin film according to any one of the first to fourth aspects, wherein the thermoplastic resin film has a fine retardation unevenness of 0% to 10%.

The thermoplastic resin film produced in the present invention may have a fine retardation unevenness of 0% to 10%. Here, the term “fine retardation unevenness” refers to the change in retardation generating in a fine region of 1 mm or less.

According to a sixth aspect of the present invention, there is provided the method for producing a thermoplastic resin film according to any one of the first to fifth aspects, wherein the thermoplastic resin is a saturated norbornene resin.

The present invention is particularly effective when the thermoplastic resin is a saturated norbornene resin.

According to a seventh aspect of the present invention, there is provided the method for producing a thermoplastic resin film according to the sixth aspect, wherein the thermoplastic resin film contains 1 ppm to 10000 ppm of fine particles having an average particle size of 0.1 μm to 3.0 μm.

The present invention is effective in the producing of a thermoplastic resin film particularly in preventing fine retardation unevenness.

According to an eighth aspect of the present invention, there is provided the method for producing a thermoplastic resin film according to any one of the first to seventh aspects, wherein the heat treatment is conducted for an unstretched thermoplastic resin film.

According to a ninth aspect of the present invention, there is provided the method for producing a thermoplastic resin film according to any one of the first to seventh aspects, wherein the heat treatment is conducted for a stretched thermoplastic resin film.

The present invention is applicable to any of an unstretched film, a thermoplastic resin film before undergoing stretching, and a stretched film, a thermoplastic resin film after undergoing stretching; however, since stretching a film makes heat shrinkage more likely to occur in the film, if the heat treatment is applied to a stretched film, the present invention is much more effective.

According to a tenth aspect of the present invention, there is provided a polarizing plate comprising at least one stacked layer of an unstretched thermoplastic resin film produced by the production method according to the eighth aspect. According to an eleventh aspect of the present invention, there is provided an optical compensation film for liquid crystal display panels, comprising, as a substrate, an unstretched thermoplastic resin film produced by the production method according to the eighth aspect. According to a twelfth aspect of the present invention, there is provided an antireflection film, comprising, as a substrate, an unstretched thermoplastic resin film produced by the production method according to the eighth aspect.

According to a thirteenth aspect of the present invention, there is provided a polarizing plate comprising at least one stacked layer of the stretched thermoplastic resin film produced according to the production method according to the ninth aspect. According to a fourteenth aspect of the present invention, there is provided an optical compensation film for liquid crystal display panels, comprising, as a substrate, a stretched thermoplastic resin film produced by the production method according to the ninth aspect. According to a fifteenth aspect of the present invention, there is provided an antireflection film, comprising, as a substrate, a stretched thermoplastic resin film produced by the production method according to the ninth aspect.

According to the present invention, a thermoplastic resin film can be produced in which heat shrinkage, a cause of color nonuniformity, is less likely to occur. Accordingly, use of a thermoplastic resin film produced in accordance with present invention makes it possible to improve the quality of a polarizing plate, an optical compensation film for liquid crystal display panels and antireflection film.

### BRIEF DESCRIPTION OF THE DRAWINGS

FIG. 1 is a block diagram showing film producing apparatus to which the present invention is applied;

FIG. 2 is a schematic view showing the construction of an extruder;

FIG. 3 is a schematic view showing the construction of filtering equipment; and

FIG. 4 is an illustration of examples of the present invention.

### DESCRIPTION OF SYMBOLS

10 . . . film producing apparatus
12 . . . saturated norbornene resin film
12′ . . . stretched saturated norbornene resin film
12″ . . . stretched saturated norbornene resin film after thermal relaxation treatment
14 . . . extruder
16 . . . die
17, 18, 19 . . . cooling drums
20 . . . film forming section
30 . . . longitudinal stretching section
40 . . . transverse stretching section
50, 50′ . . . winding-up sections
70 . . . thermal relaxation equipment
71 . . . furnace
72 . . . pass rollers
74 . . . nip rolls
76 . . . tension measuring roll

### BEST MODE FOR CARRYING OUT THE INVENTION

In the following a preferred embodiment of the method for producing a thermoplastic resin film of the present invention will be described with reference to the accompanying drawings. While this embodiment will be described in terms of producing a saturated norbornene resin film as a thermoplastic resin film, the present invention is not limited to this, but is applicable to producing other kinds of thermoplastic resin films such as a polycarbonate resin film.

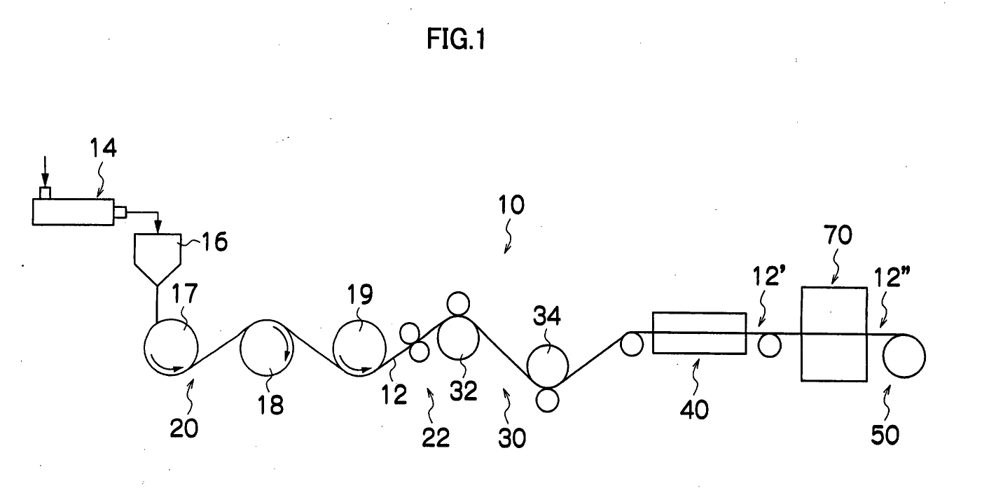

FIG. 1 is a schematic diagram showing one example of apparatus for producing a thermoplastic resin film of the present invention. The apparatus will be described in terms of a case where a stretched thermoplastic resin film is produced employing melt film forming method.

As shown in FIG. 1, a production apparatus 10 mainly comprises a film-forming process 20 for forming a saturated norbornene resin film 12 before stretching; a longitudinal stretching process 30 and a transverse stretching process 40 for longitudinally and transversely, respectively, stretching the saturated norbornene resin film 12 formed in the film-forming process 20; a heat treatment process 70 for heat-treating a stretched saturated norbornene resin film 12′; and a winding process 50 for winding a stretched saturated norbornene resin film after thermal relaxation treatment 12″. The heat treatment process is described in the present embodiment as an on-line heat treatment process which is incorporated in the production apparatus 10, but an off-line heat treatment process may be employed in which the film is heat-treated in a separate heat treatment line after it is temporarily wound at the winding process 50. Moreover, a stretched film is heat-treated in the present embodiment, but an unstretched saturated norbornene resin film may be heat-treated.

In the film-forming process 20, a saturated norbornene resin which is molten in an extruder 14 is extruded from a die 16 in a sheet form and is cast onto a rotating drum 17. The molten resin is cooled and solidified on the surface of drums 17, 18 and 19 to provide the saturated norbornene resin film 12. The saturated norbornene resin film 12 is stripped off from the drum 19, and then sent in turn to the longitudinal stretching process 30 and the transverse stretching process 40 for stretching and wound into a roll form at the winding process 50. Thus, the stretched saturated norbornene resin film 12′ is produced.

The detail of each process will be described below.

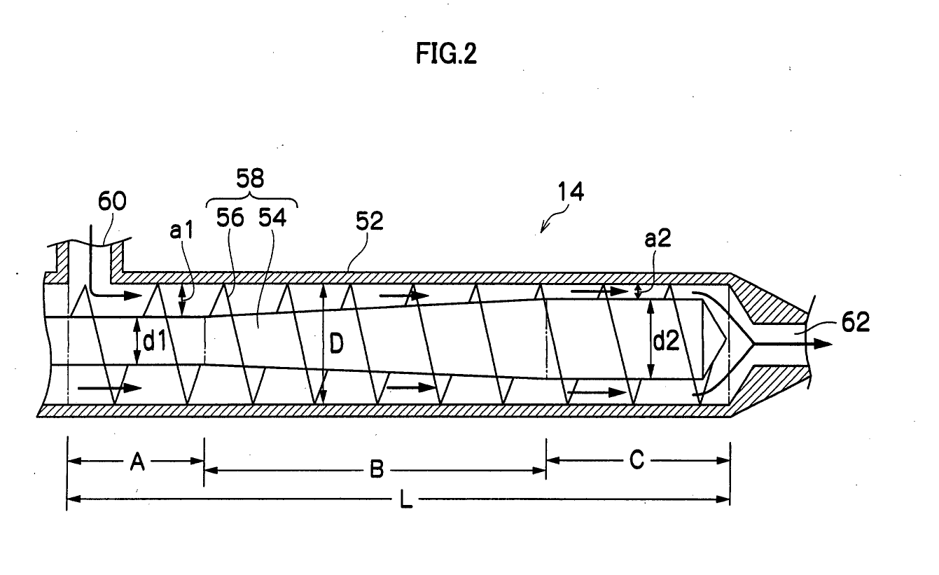

FIG. 2 shows the construction of the extruder 14 in the film-forming process 20. As shown in FIG. 2, a cylinder 52 of the extruder 14 is provided with a monoaxial screw 58 composed of a screw shaft 54 with a flight 56 attached thereon, wherein the monoaxial screw 58 is rotated by a motor (not shown).

A feed opening 60 of the cylinder 52 is provided with a hopper (not shown), from which the saturated norbornene resin is supplied into the cylinder 52 through the feed opening 60.

The cylinder 52 is constructed of, in turn from the feed opening 60 side, a feed zone (a region indicated by A) for transporting constant volume of the saturated norbornene resin fed from the feed opening 60; a compression zone (a region indicated by B) for kneading and compressing the saturated norbornene resin; and a metering zone (a region indicated by C) for metering the kneaded and compressed saturated norbornene resin. The saturated norbornene resin molten in the extruder 14 is continuously sent to the die 16 from a discharge port 62.

The screw compression ratio of the extruder 14 is set to 2.5 to 4.5 and L/D to 20 to 70. The term “screw compression ratio” herein used means the volume ratio of the feeding section A to the measuring section C, in other words, the volume per unit length of the feeding section A÷the volume per unit length of the measuring section C, and it is calculated using the outside diameter d1 of the screw shaft 34 of the feeding section A, the outside diameter d2 of the screw shaft 34 of the measuring section C, the diameter a1 of the flight channel of the feeding section A and the diameter a2 of the flight channel of the measuring section C. The term “L/D” herein used means the ratio of the length (L) to the inside diameter (D) of the cylinder shown in FIG. 2. The extrusion temperature (the outlet temperature of the extruder) is set to 190 to 240° C. When the temperature inside the extruder 14 is higher than 240° C., a refrigerator (not shown in the figure) should be provided between the extruder 14 and the die 24.

The extruder 14 may be either a single-screw extruder or a twin-screw extruder. However, if the screw compression ratio is as low as less than 2.5, the thermoplastic resin is not fully kneaded, thereby causing an unmolten part, or the magnitude of heat evolution by shear stress is too small to sufficiently fuse crystals, thereby making fine crystals more likely to remain in the formed saturated norbornene resin film. Furthermore, the saturated norbornene resin film is made more likely to include air bubbles. Thus, in stretching of the saturated norbornene resin film 12, the remaining crystals inhibit the stretchability of the film, whereby the degree of film orientation cannot be sufficiently increased. Conversely, if the screw compression ratio is as high as more than 4.5, the magnitude of heat evolution by shear stress is so large that the resin becomes more likely to deteriorate by heat, which makes the formed saturated norbornene resin film more likely to yellow. Further, too large shear stress causes molecule breakage, which results in decrease in molecular weight, and hence in mechanical strength of the film. Accordingly, to make the formed saturated norbornene resin film less likely to yellow and less likely to break in stretching, the screw compression ratio is preferably in the range of 2.5 to 4.5, more preferably in the range of 2.8 to 4.2, and particularly preferably in the range of 3.0 to 4.0.

The L/D as low as less than 20 causes insufficient melting or insufficient kneading, which makes fine crystals more likely to remain in the formed saturated norbornene resin film, like the case where the compression ratio is too low. Conversely, the L/D as high as more than 70 makes too long the residence time of the saturated norbornene resin in the extruder 14, which makes the resin more likely to deteriorate. Too long a residence time may cause molecule breakage, which results in decrease in molecular weight, and hence in mechanical strength of the film. Accordingly, to make the formed saturated norbornene resin film less likely to yellow and less likely to break in stretching, the L/D is preferably in the range of 20 to 70, more preferably in the range of 22 to 45, and particularly preferably in the range of 24 to 40.

If the extrusion temperature is as low as lower than 190° C., crystals are not sufficiently melted, which makes fine crystals more likely to remain in the formed saturated norbornene resin film. As a result, when stretching the saturated norbornene resin film, the remaining crystals inhibit the stretchability of the film, whereby the degree of film orientation cannot be sufficiently increased. Conversely, if the extrusion temperature is as high as higher than 240° C., the saturated norbornene resin deteriorates, which causes the degree of yellow (YI value) to increase. Accordingly, to make the formed saturated norbornene resin film less likely to yellow and less likely to break in stretching, the extrusion temperature is preferably in the range of 190° C. to 240° C., more preferably in the range of 195° C. to 235° C., and particularly preferably in the range of 200° C. to 230° C.

The molten resin is continuously fed to the die 16 in FIG. 1. The fed molten resin is discharged from the leading end (lower end) of the die 16 in a sheet form. The discharged molten resin is cast onto the drum 17, cooled and solidified on the surface of the drums 17, 18 and 19, and then stripped off from the surface of the drum 19, forming the saturated norbornene resin film 12.

The saturated norbornene resin film 12 formed in the film-forming process 20 is sent in turn to the longitudinal stretching process 30 and the transverse stretching process 40. The stretching process will be described below in which the saturated norbornene resin film 12 produced in the film-forming process 20 is stretched, producing the stretched saturated norbornene resin film 12′.

Stretching of the saturated norbornene resin film 12 is performed so as to orient the molecules in the saturated norbornene resin film 12 and develop the in-plane retardation (Re) and the retardation across the thickness (Rth) in the film. The retardations Re and Rth are obtained from the following equations.

Re(nm)=|n(MD)−n(TD)|×T(nm)

Rth(nm)=|{(n(MD)+n(TD))/2}−n(TH)|×T(nm)

The characters, n(MD), n(TD) and n(TH), in the above equations indicate the refractive indexes across the length, across the width and across the thickness, respectively, and the character T the thickness in nm.

As shown in FIG. 1, the saturated norbornene resin film 12 is first stretched in the longitudinal direction in the longitudinal stretching section 30. In the longitudinal stretching section 30, the saturated norbornene resin film 12 is preheated and the saturated norbornene resin film 12 in the heated state wound around the two nip rolls 32, 34. The nip roll 34 on the outlet side conveys the saturated norbornene resin film 12 at higher conveying speeds than the nip roll 32 on the inlet side, whereby the saturated norbornene resin film 12 is stretched in the longitudinal direction.

The saturated norbornene resin film 12 having been stretched longitudinally is fed to the transverse stretching section 40 where it is stretched across the width. In the transverse stretching section 40, a tenter is suitably used. The tenter stretches the saturated norbornene resin film 12 in the transverse direction while fastening both side ends of the film 12 with clips. This transverse stretching can further increase the retardation Rth.

The stretched norbornene resin film 12 in which retardation Re and Rth is developed can be obtained by subjecting the film to longitudinal and transverse stretching treatment as described above. Preferably, such stretching provides a stretched saturated norbornene resin film having: a thickness of 30 to 300 μm; an in-plane retardation (Re) of 0 nm or more and 500 nm or less, more preferably 10 nm or more and 400 nm or less and much more preferably 15 nm or more and 300 nm or less; and a retardation across the thickness (Rth) of 30 nm or more and 500 nm or less, more preferably 50 nm or more and 400 nm or less and much more preferably 70 nm or more and 350 nm or less. Of the stretched saturated norbornene resin films described above, those satisfy the formula, Re≦Rth, are more preferable and those satisfy the formula, Re×2≦Rth, are much more preferable. To realize such a high Rth and a low Re, it is preferable to stretch the saturated norbornene resin film having been stretched longitudinally in the transverse direction (across the width). Specifically, in-plane retardation (Re) represents the difference between the orientation in the longitudinal direction and the orientation in the transverse direction, and if the stretching is performed not only in the longitudinal direction, but in the transverse direction—the direction perpendicular to the longitudinal direction, the difference between the orientation in the longitudinal direction and the orientation in the transverse direction can be decreased, and hence the in-plane retardation (Re). And at the same time, stretching in both the longitudinal and transverse directions increases the area magnification, and therefore, the orientation across the thickness increases with decrease in the thickness, which in turn increases Rth.

Further, fluctuations in Re and Rth in the transverse direction and the longitudinal direction depending on locations are kept preferably 5% or less, more preferably 4% or less and much more preferably 3% or less. Moreover, the orientation angle is preferably 90°±5° or 0°±5°, more preferably 90°±3° or less or 0°±3° or less, and most preferably 90°±1° or less or 0°±1° or less. Bowing can be reduced by the stretching treatment as described in the present invention. It is preferred that the bowing strain be 10% or less, preferably 5% or less, and more preferably 3% or less, wherein the bowing strain is defined as the deviation, at the center part of a straight line drawn along the width direction on the surface of the saturated norbornene resin film 12 before entering the tenter which is deformed to a concave shape after the completion of stretching, divided by the width.

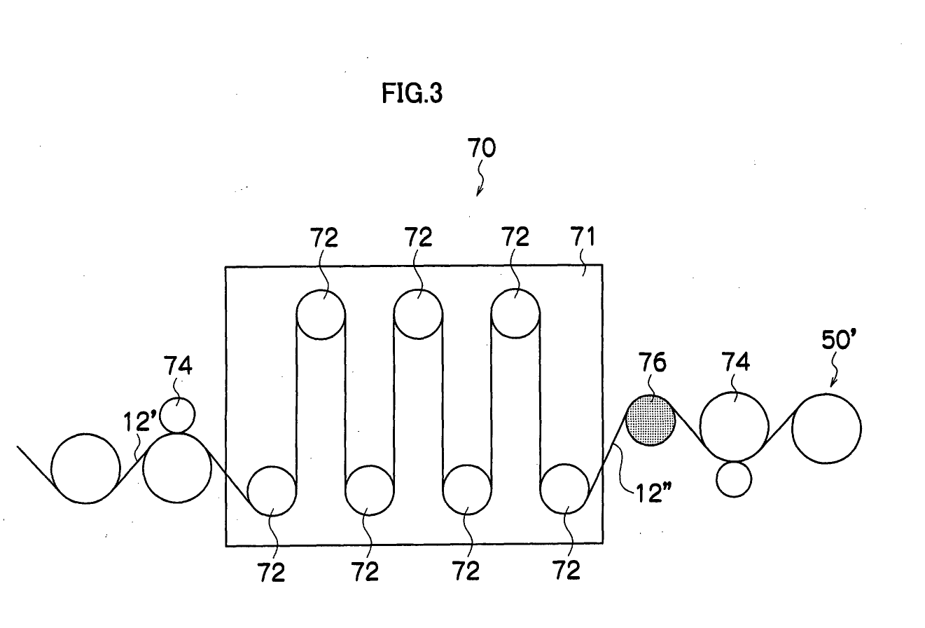

Next, the heat treatment process 70 according to the present invention will be described. FIG. 3 shows an example of the construction of a thermal relaxation device 70 used in the present invention. The heat treatment process 70 is applied to the stretched saturated norbornene resin film 12′ which is stretched in the longitudinal stretching process 30 and the transverse stretching process 40 in FIG. 1. Therefore, the heat treatment may be applied to the film after the transverse stretching process 40 and before the winding process 50, or may be applied to the stretched saturated norbornene resin film 12′ temporarily wound at the winding process 50 after longitudinal and transverse stretching by transporting the film to a device composed only of the heat treatment process. Moreover, it will be appreciated that the stretched saturated norbornene resin film 12′ may be a commercially available stretched film other than the film produced by the apparatus according to the present invention.

The thermal relaxation device 70 is provided with path rollers 72 for conveying a stretched saturated norbornene resin film 12′ in an oven 71 for controlling temperature. In order to convey the stretched saturated norbornene resin film 12′ while maintaining a low tension of the film, a nip roll 74 is preferably used for conveying the film to the oven 71 and pulling the film out of the oven. In this way, it is possible to maintain the low tension by measuring the tension by a tension-measuring roll 76 and then changing the rotational speed of the nip roll 74 as required. Alternatively, a suction drum may be used for performing tension cut instead of the nip roll 74.

The stretched saturated norbornene resin film 12′ is heat-treated at a temperature of Tg−30° C. to Tg+20° C. for 10 seconds to 600 seconds while conveyed at a tension of 2 N/cm² to 120 N/cm². The film is conveyed at a tension of 2 N/cm² or more because the tension less than 2 N/cm² causes the slack of the stretched saturated norbornene resin film 12′. The film is conveyed at a tension of 120 N/cm² or less because the tension more than 120 N/cm² causes an additional stretching of the stretched saturated norbornene resin film 12′, and so it is impossible to reduce heat shrinkage. The film is heat-treated at a temperature of Tg−30° C. or higher, because when the temperature is lower than Tg−30° C., the heat treatment will not be effective. The film is heat-treated at a temperature of Tg+20° C. or lower, because when the temperature is higher than Tg+20° C., optical properties such as Re and Rth of the stretched saturated norbornene resin film 12′ will be changed. The film is heat-treated for a period of time of 10 seconds or more, because when the period of time is less than 10 seconds, the heat treatment will not be effective. The film is heat-treated at a period of time of 600 seconds or less, because when the period of time is more than 600 seconds, optical properties such as Re and Rth of the stretched saturated norbornene resin film 12′ will be changed. The tension is generally in the range of 2 N/cm² to 120 N/cm², preferably in the range of 5 N/cm² to 100 N/cm², more preferably in the range of 8 N/cm² to 80 N/cm², and most preferably in the range of 10 N/cm² to 40 N/cm². The temperature is preferably in the range of Tg−30° C. to Tg+20° C., more preferably in the range of Tg−20° C. to Tg+15° C., more preferably in the range of Tg−10° C. to Tg+10° C., and most preferably in the range of Tg−5° C. to Tg+5° C.

The thus obtained stretched saturated norbornene resin film 12″ after thermal relaxation treatment may have both a dimensional change under wet heating (δL(w)) and a dimensional change under dry heating (δL(d)) in the range of 0% to 0.3%. Further, in the film 12″, all of the change of in-plane retardation (Re) under wet heating (δRe (w)), the change of in-plane retardation (Re) under dry heating (δRe(d)), the change of retardation in the thickness direction (Rth) under wet heating (δRth(w)), and the change of retardation in the thickness direction (Rth) under dry heating (δRth(d)) may be in the range of 0% to 10%. As described herein the term “wet heating” refers to the condition where the film is left standing in an atmosphere of 90% RH at 60° C. for 500 hours, and the term “dry heating” refers to the condition where the film is left standing in an atmosphere of 10% RH or less at 80° C. for 500 hours. The change is determined relative to the film which is conditioned in an atmosphere of a temperature of 25° C. and a humidity of 60% RH for 5 hours or more. As described herein the term “retardation” refers to a retardation value to the light having a wavelength of 550 nm incident upon the film surface in the vertical direction thereof in an atmosphere of a temperature of 25° C. and a humidity of 60% RH after the film is conditioned in an atmosphere of the same condition for 5 hours or more. For example, the retardation value can be measured by use of an automatic birefringence analyzer (KOBRA-21ADH/PR: manufactured by Oji Scientific Instruments).

The δL(d) refers to a larger value of the dimensional change (δMD(d)) in the longitudinal direction (MD) and the dimensional change (67TD(d)) in the width direction (TD) as represented by the following formulas. Incidentally, “dry” refers to the condition where relative humidity is 10% or less.

δTD(d)(%)=100×|TD(F)−TD(T)|/TD(F)

δMD(d)(%)=100×|MD(F)−MD(T)|/MD(F)

(wherein TD(F) and MD(F) each denote the dimension before “thermo-treatment” (which refers to the exposure of the film to a dry atmosphere at 80° C. for 500 hours) measured in an atmosphere of 25° C. and 60% rh after the film is left standing in the same atmosphere for 5 hours or more; and TD(T) and MD(T) each denote the dimension after the “thermo” measured in an atmosphere of 25° C. and 60% rh after the film is left standing in the same atmosphere for 5 hours or more)

The δL(w) refers to a larger value of the dimensional change (δMD(w)) in the longitudinal direction (MD) and the dimensional change (δTD(w)) in the width direction (TD) as represented by the following formulas.

δTD(w)(%)=100×|TD(F)−TD(t)|/TD(F)

δMD(w)(%)=100×|MD(F)−MD(t)|/MD(F)

(wherein TD(F) and MD(F) each denote the dimension before “thermo-treatment” (which refers to the exposure of the film to a wet atmosphere of 60° C. and 90% rh for 500 hours) measured in an atmosphere of 25° C. and 60% rh after the film is left standing in the same atmosphere for 5 hours or more; and TD(t) and MD(t) each denote the dimension after the “thermo” measured in an atmosphere of 25° C. and 60% rh after the film is left standing in the same atmosphere for 5 hours or more)

Desirable δL(w) and δL(d) are preferably from 0% to 0.3%, more preferably from 0% to 0.2%, and most preferably from 0% to 0.15%.

The δRe(d) and δRth(d) in the present invention refer to the change of Re and Rth, respectively, before and after exposing the film to a dry atmosphere at 80° C. for 500 hours and are represented by the following formulas. Incidentally, “dry” refers to the condition where relative humidity is 10% or less.

δRe(d)(%)=100×|Re(F)−Re(T)|/Re(F)

δRth(d)(%)=100×|Rth(F)−Rth(T)|/Rth(F)

(wherein Re(F) and Rth(F) each denote the Re and Rth, respectively, before exposing the film to a dry atmosphere at 80° C. for 500 hours; and Re(T) and Rth(T) each denote the Re and Rth, respectively, after exposing the film to a dry atmosphere at 80° C. for 500 hours)

The δRe(w) and δRth(w) in the present invention refer to the change of Re and Rth, respectively, before and after exposing the film to an atmosphere of 60° C. and 90% rh for 500 hours and are represented by the following formulas:

δRe(w)(%)=100×|Re(F)−Re(t)|/Re(F)

δRth(w)(%)=100×|Rth(F)−Rth(t)|/Rth(F)

(wherein Re(F) and Rth(F) each denote the Re and Rth, respectively, before exposing the film to an atmosphere of 60° C. and 90% rh for 500 hours; and Re(t) and Rth(t) each denote the Re and Rth, respectively, after exposing the film to an atmosphere of 60° C. and 90% rh for 500 hours)

Moreover, the saturated norbornene resin film has a fine retardation unevenness of preferably from 0% to 10%, more preferably from 0% to 8%, and most preferably from 0% to 5%. This reduces color nonuniformity. Incidentally, such fine retardation unevenness has become a problem with the shift of liquid crystal display devices to those of high resolution.

As described herein the term “fine retardation unevenness” refers to the change in retardation generating in a fine region of 1 mm or less, and it is determined by the following method.

In-plane retardation (Re) values are measured for 1 mm of a sample film at a pitch of 0.1 mm in the transverse direction (TD) and in the longitudinal direction (MD). The term “in-plane retardation (Re)” herein is the difference of the maximum in-plane retardation (Re) value and the minimum in-plane retardation (Re) value divided by the average of the in-plane retardation (Re) values, which is shown as a percentage. The larger one of the above described percentage determined for MD and TD is defined as the fine retardation unevenness.

Preferably the saturated norbornene film contains 1 ppm or more and 10000 ppm or less fine particles.

Addition of fine particles as lubricant makes it possible to prevent the film from sticking to the nip roll during the longitudinal stretching operation, thereby preventing the fine retardation unevenness resulting from the sticking. During the longitudinal stretching operation, the film is stretched on the nip roll at temperatures higher than the Tg of the saturated norbornene resin and softening the film; therefore, without a lubricant, the film is likely to stick locally to the nip roll, which is likely to cause stretching non-uniformity. In other words, the fine particles added allow the nip roll and the film to slide over each other, thereby preventing the film from being locally stressed.

Preferably, fine particles are added as a matting agent. Examples of fine particles used in the present invention include: those of silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Fine particles comprising a crosslinked polymer can also be used as a matting agent.

These fine particles generally form secondary particles having an average particle size of 0.1 to 3.0 μm, which exist as agglomerates of primary particles in a film and form irregularities 0.1 to 3.0 μm in size on the film surface. The average secondary particle size is preferably 0.2 μm or more and 1.5 μm or less, more preferably 0.4 μm or more and 1.2 μm or less, and most preferably 0.6 μm or more and 1.1 μm or less. The primary particle size and the secondary particle size are determined by observing the particles in the film with a scanning electron microscope and using the diameter of the circle circumscribing each particle as a particle size. The average particle size is obtained by averaging the 200 determinations resulting from observation at different sites.

Preferably the amount of the fine particles added is 1 ppm to 10000 ppm by weight relative to the amount of saturated norbornene resin, more preferably 5 ppm to 7000 ppm, and more preferably 10 ppm to 5000 ppm.

As fine particles, those containing silicon are preferable, because the turbidity of the film can be lowered using fine particles containing silicon. Particularly preferable are fine particles of silicon dioxide. Preferably, the fine particles of silicon dioxide have an average primary particle size of 20 nm or larger and an apparent specific gravity of 70 g/liter or higher. Fine particles having an average primary particle size as small as 5 to 16 nm are more preferable, because the haze of the film can be decreased using such fine particles. The apparent specific gravity is preferably 90 to 200 g/liter or higher and more preferably 100 to 200 g/liter or higher. Use of fine particles having a higher apparent specific gravity is preferable, because it makes it possible to prepare a higher concentration of dispersant, which results in improvement in the haze of the film or agglomerates of the fine particles.

As fine particles of silicon dioxide, those commercially available, such as Aerosil R972, R972V, R974, R812, 200, 200V, 300, R202, OX50 and TT600 (manufactured by Nippon Aerosil Co., LTD), can be used. As fine particles of zirconium oxide, those on the market under the trade name of Aerosil R976 and R811 (manufactured by Nippon Aerosil Co., LTD) can be used.

Of these fine particles, Aerosil 200V and Aerosil R972V are particularly preferable, because they are fine particles of silicon dioxide having an average primary particle size of 20 nm or less and an apparent specific gravity of 70 g/liter more and they produce a large effect of reducing friction coefficient of the optical film produced while keeping the turbidity of the same low.

In the following, saturated norbornene resins suitably used for the present the invention and method of processing a saturated norbornane resin film will be described in detail following the procedure.

### <Saturated Norbornene Resin>

In the present invention, other cycloolefins capable of undergoing ring opening polymerization can be used together with a saturated norbornene resin, as long as their use impairs the object of the present invention. Concrete examples of such cycloolefins include: compounds having one reactive double bond, such as cyclopentene, cyclooctene and 5,6-dihydrodicyclopentadiene.

Preferably such stretching is conducted for the saturated norbornene films described below. Because these films have properties of developing proper Re, Rth and excel in that the Re, Rth are less likely to vary over time even at high temperature and high humidity, and thus, fine Re non-uniformity is less likely to occur.

As such saturated norbornene resins, both saturated norbornene resin-A and saturated norbornene resin-B, described below, are preferably used. Although both solution film forming method and melt film forming method are applicable to both resins, preferably melt film forming method is used for the saturated norbornene resin-A and solution film forming method is used for the saturated norbornene resin-B.

### (Saturated Norbornene Resin-A)

Example of saturated norbornene resins used in the present invention include: (1) resins obtained by subjecting polymer resulting from ring opening (co)polymerization of norbornene monomer to polymer modification, such as addition of maleic adic or that of cyclopentadiene, depending on the situation and then hydrogenating the modified polymer; (2) resins obtained by subjecting norbornene monomer to addition-type polymerization; (3) resins obtained by subjecting norbornene monomer and olefin monomer, such as ethylene or α-olefin, to addition-type copolymerization. Polymerization and hydrogenation can be performed by a conventional method.

Examples of norbornene monomers include: norbornene; alkyl and/or alkylidene-substituted derivatives thereof, such as 5-methyl-2-norbornene, 5-dimethyl-2-norbornene, 5-ethyl-2-norbornene, 5-butyl-2-norbornene, 5-ethylidene-2-norbornene; derivatives thereof substituted with a polar group such as halogen; dicyclopentadiene and 2,3-hydrodicyclopentadiene; dimethanooctahydronaphthalene; alkyl and/or alkylidene-substituted derivatives thereof and derivatives thereof substituted with a polar group such as halogen, such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene; addition products of cyclopentadiene and tetrahydroindene; and trimers or tetramers of cyclopentadiene, such as 4,9:5,8-dimethano-3a,4,4a,5,8,8a,9,9a-octahydro-1H-benzoindene, 4, 11:5, 10:6,9-trimethano-3a,4,4a,5,5a,6,9,9a,10,10a, 11,11a-dodecahydro-1H-cyclopentaa nthracene.

### (Saturated Norbornene Resin-B)

Examples of saturated norbornene resins include: those expressed by the following chemical formulas (general formulas) (1) to (4). Of these resins, those expressed by the following chemical formula (I) are particularly preferable.

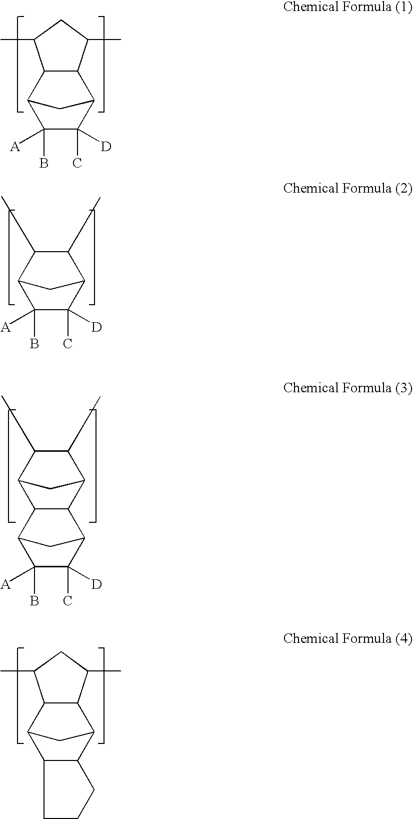

[In the chemical formulas (1) to (4), A, B, C and D each represent a hydrogen atom or a univalent organic group, at least one of which is a polar group.]

Generally, the weight average molecular weight of these saturated norbornene resins is preferably 5,000 to 1,000,000 and more preferably 8,000 to 200,000.

Examples of the saturated norbornene resins used in the present invention include: resins described in Japanese Patent Laid-Open Nos. 60-168708, 62-252406, 62-252407, 2-133413, 63-145324, 63-264626 and 1-240517, and Japanese Patent Publication No. 57-8815.

Of these resins, particularly preferable are hydrogenated polymers obtained by hydrogenating the polymers resulting from ring opening polymerization of norbornene monomers.

Preferably the glass transition temperature (Tg) of these saturated norbornene resins is 120° C. or higher and more preferably 140° C. or higher. The saturated water absorption of the same is preferably 1% by weight or less and more preferably 0.8% by weight or less. The glass transition temperature (Tg) and saturated water absorption of the saturated norbornene resins expressed by the above chemical formulas (1) to (4) can be controlled by selecting the kind of the substitute A, B, C or D.

As a saturated norbornene resin, at least one kind of tetracyclododecene derivatives having the following formula (5) alone or a hydrogenated polymer obtained by hydrogenating a polymer resulting from the metathesis polymerization of one kind of tetracyclododecene derivatives and an unsaturated cyclic compound copolymerizable therewith in combination may be used.

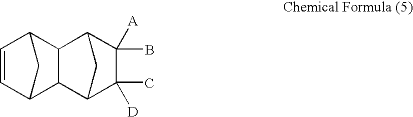

(wherein A, B, C and D each represent a hydrogen atom or a univalent organic group, at least one of which is a polar group.)

That at least one of A, B, C and D in the tetracyclododecene derivatives expressed by the above formula (5) is a polar group makes it possible to obtain a polarization film which excels in adhesion to other materials and resistance to heat. It is preferable that the polar group is a group expressed by —(CH₂)ₙCOOR (wherein R is a hydrocarbon group with 1 to 20 carbons, n is an integer of 0 to 10), because such a polar group allows the hydrogenated polymer, as a final product, (substrate for polarization film) to have a high glass transition temperature. Further, it is preferable, from the viewpoint of decreasing the water absorption of the saturated norbornene resin, that the tetracyclododecene derivatives expressed by the above formula (5) contain one polar substitute expressed by —(CH₂)ₙCOOR per molecule. In the above described polar substitute, it is preferable that the hydrocarbon group expressed by R contains a larger number of carbon atoms, because the larger the number of carbon atoms, the smaller the water absorption of the hydrogenated polymer. However, taking into consideration the balance between the water absorption and the glass transition temperature of the hydrogenated polymer, preferably the hydrocarbon group expressed by R is a chain alkyl group with 1 to 4 carbon atoms or a (poly)cyclic alkyl group with 5 or more carbon atoms. Particularly preferably it is a methyl, ethyl or cyclohexyl group.

Further, tetracyclododecene derivatives expressed by the above formula (5) in which a hydrocarbon group with 1 to 10 carbon atoms is bonded, as a substitute, to the carbon atom to which a group expressed by —(CH₂)ₙCOOR is bonded are preferable, because they allow the resultant hydrogenated polymer to have a low water absorption. Tetracyclododecene derivatives expressed by the above formula (5) in which the above described substitute is a methyl or ethyl group is particularly preferable, because such tetracyclododecene derivatives are easy to synthesize. Specifically, 8-methyl-8-methoxycarbonyltetracyclo[4,4,0,12.5,17.10]dodeca-3-ene is preferable. These tetracyclododecene derivatives and the mixtures with unsaturated cyclic compounds copolymerizable thereof can be metathesis-polymerized or hydrogenated by the process described in, for example, Japanese Patent Laid-Open No. 4-77520, at the upper right of p. 4, 1.12 to at the lower right of p. 6, 1.6.

The intrinsic viscosity (η inh) of these norbornene resins measured in chloroform at 30° C. is preferably 0.1 to 1.5 dl/g and more preferably 0.4 to 1.2 dl/g. The hydrogenation rate of the hydrogenated polymer is, when measured at 60 MHz, 1H-NMR, preferably 50% or higher, more preferably 90% or higher, and much more preferably 98% or higher. The higher the hydrogenation rate, the more stable to heat or light the resultant saturated norbornene film. The gel content in the hydrogenated polymer is preferably 5% by weight or less and more preferably 1% by weight or less.

The saturated norbornene resins used in the present invention can be stabilized by adding a known antioxidant, such as 2,6-di-t-butyl-4-methylphenol, 2,2′-dioxy-3,3′-di-t-butyl-5,5′-dimethylphenylmethane, tetrakis[methylene-3-(3,5-di-t-butyl-4-hydroxyphenyl)propionate]methane, 1,1,3-tris(2-methyl-4-hydroxy-5-t-butylphenyl)butane, 1,3,5-trimethyl-2,4,6-tris(3,5-di-t-butyl-4-hydroxybenzyl)benzene, stearyl-β-(3,5-di-t-butyl-4-hydroxyphenyl)propionate, 2,2′-dioxy-3,3′-di-t-butyl-5,5′-diethylpnylmethane, 3,9-bis[1,1-dimethyl-2-[β-(3-t-butyl-4-hydroxy-5-methylphenyl)propionyloxy]ethyl], 2,4,8,10-tetraoxyspiro[5,5]undecane, tris(2,4-di-t-butylphenyl)phosphite, cyclic neopentanetetralbis(2,4-di-t-butylphenyl)phosphite, cyclic neopentanetetraylbis(2,6-di-t-butyl-4-methylphenyl)phosphite, 2,2-methylenebis(4,6-di-t-butylphenyl)octyl phosphite; or an ultraviolet absorber, such as 2,4-dihydroxybenzophenone or 2-hydroxy-4-methoxybenzophenone. Further, to improve the processability, other additives such as lubricant can also be added.

The amount of the antioxidant added is usually 0.1 to 3 parts by weight per 100 parts of saturated norbornene resin and preferably 0.2 to 2 parts by weight.

Further, if desired, various additives, such as a phenol or phosphorus anti-aging agent, antistatic agent, ultraviolet absorber, or lubricant as described above, may be added to saturated norbornene resins. In particular, liquid crystal generally deteriorates when exposed to ultraviolet light; and therefore, if any protective means, such as stacking of an ultraviolet protective filter, is not used, it is preferable to use an ultraviolet absorber. Examples of ultraviolet absorbers applicable include: benzophenone, benzotriazole and acrylnitrile ultraviolet absorbers. Of these ultraviolet absorbers, benzophenone ultraviolet absorbers are preferable. The amount of such an ultraviolet absorber added is usually 10 to 100,000 ppm and preferably 100 to 10,000 ppm. When a sheet of molten resin is formed by solution casting process, to decrease the surface roughness of the sheet, it is preferable to add a leveling agent. Examples of leveling agents applicable include: fluorine-type nonionic surfactants, special acrylic resin-type leveling agents, and silicone-type leveling agents. Of these leveling agents, one compatible with the solvent used is preferable, and the amount of such a leveling agent added is usually 5 to 50,000 ppm and preferably 10 to 20,000 ppm.

### (Melt Film Formation)

### (i) Melting

Before used for film formation by melt film forming method, the saturated norbornene resin is preferably pelletized. Pelletizing the saturated norbornene resin makes it possible to suppress the surging in the hopper of a melt extruder, thereby ensuring stable feeding of the resin. The pellet cross-sectional area and the pellet length are 1 mm² to 300 mm² and 1 mm to 30 mm, respectively, and more preferably 2 mm² to 100 mm² and 1.5 mm to 10 mm, respectively.

The pellets of the saturated norbornene resin are fed into a melt extruder, dehydrated at a temperature 100° C. or higher and 200° C. or lower for 1 minute or longer and 10 hours or shorter, and kneaded and extruded. The kneading can be performed using a single-screw or twin-screw extruder.

The saturated norbornene resin having been kneaded is fed into a cylinder through the feed opening of the extruder. The cylinder is made up of: a feeding section where the saturated norbornene resin fed through the feed opening is transported in a fixed amount (area A); a compressing section where the saturated norbornene resin is melt kneaded and compressed (area B); and a measuring section where measurement is made (area C), from the feed opening side in this order. To prevent the molten resin from being oxidized by oxygen remaining in the extruder, it is preferable to carry out the above described operations in the stream of an inert gas (e.g. nitrogen) or while performing vacuum evacuation using an extruder equipped with a vent. The screw compression ratio of the extruder is set to 2.5 to 4.5 and L/D is set to 20 to 70. The “screw compression ratio” herein used means the volume ratio of the feeding section A and the measuring section C, in other words, the value obtained by dividing the volume of the feeding section A per unit length by the volume of the measuring section C per unit length, which is calculated using the outside diameter d1 of the screw shaft of the feeding section A, the outside diameter d2 of the screw shaft of the measuring section C, the diameter a1 of the groove portion of the feeding section A, and the diameter a2 of the groove portion of the measuring section C. The “L/D” herein used means the ratio of the length of the cylinder to the inside diameter of the cylinder. The extrusion temperature is set to 240° C. to 320° C., preferably to 250° C. to 310° C., and more preferably to 260° C. to 300° C.

As extruder, generally single-screw extruder, which requires lower equipment costs, is often used. Types of single-screw extruder include: for example, fullflight-type, Madock-type and Dulmage-type. For the saturated norbornene resin, which is relatively poor in heat stability, fullflight-type screw extruder is preferably used. Twin-screw extruder which is provided with a vent midway along its length, and therefore, makes it possible to perform extrusion while removing unnecessary volatile components can also be used by changing the screw segment, though it requires high equipment costs. Types of twin-screw extruder include: broadly, corotating type and counter-rotating type, and either of the types can be used. However, preferably used is a corotating type of twin-screw extruder which causes less residence of the resin and has a high self-cleaning performance. Twin-screw extruder is suitable for the film formation of saturated norbornene resin, because it makes possible extrusion at low temperatures due to its high kneading performance and high resin-feeding performance, though its equipment costs are high. In twin-extruder, if a vent opening is properly arranged, pellets or powder of saturated norbornene resin can be used in the undried state or the selvedges of the film produced in the course of the film formation can also be reused in the undried state.

The preferable diameter of the screw varies depending on the intended amount of the saturated norbornene resin extruded per unit time; however, it is preferably 10 mm or larger and 300 mm or smaller, more preferably 20 mm or larger and 250 mm or smaller, and much more preferably 30 mm or larger and 150 mm or smaller.

### (ii) Filtration

To filter contaminants in the resin or avoid the damage to the gear pump caused by such contaminants, it is preferable to perform a so-called breaker-plate-type filtration which uses a filter medium provided at the extruder outlet. To filter contaminants with much higher precision, it is preferable to provide, after the gear pump, a filter in which a leaf-type disc filter is incorporated. Filtration can be performed with a single filtering section, or it can be multi-step filtration with a plurality of filtering sections. A filter medium with higher precision is preferably used; however, taking into consideration the pressure resistance of the filter medium or the increase in filtration pressure due to the clogging of the filter medium, the filtration precision is preferably 15 μm to 3 μm and more preferably 10 μm to 3 μm. A filter medium with higher precision is particularly preferably used when a leaf-type disc filter is used to perform final filtration of contaminants. And in order to ensure suitability of the filter medium used, the filtration precision may be adjusted by the number of filter media loaded, taking into account the pressure resistance and filter life. From the viewpoint of being used at high temperature and high pressure, the type of the filter medium used is preferably a steel material. Of the steel materials, stainless steel or steel is particularly preferably used. From the viewpoint of corrosion, desirably stainless steel is used. A filter medium constructed by weaving wires or a sintered filter medium constructed by sintering, for example, metal long fibers or metal powder can be used. However, from the viewpoint of filtration precision and filter life, a sintered filter medium is preferably used.

(iii) Gear Pump

To improve the thickness precision, it is important to decrease the fluctuation in the amount of the discharged resin and it is effective to provide a gear pump between the extruder and the die to feed a fixed amount of saturated norbornene resin through the gear pump. A gear pump is such that it includes a pair of gears—a drive gear and a driven gear—in mesh, and it drives the drive gear to rotate both the gears in mesh, thereby sucking the molten resin into the cavity through the suction opening formed on the housing and discharging a fixed amount of the resin through the discharge opening formed on the same housing. Even if there is a slight change in the resin pressure at the tip of the extruder, the gear pump absorbs the change, whereby the change in the resin pressure in the downstream portion of the film forming apparatus is kept very small, and the fluctuation in the film thickness is improved. The use of a gear pump makes it possible to keep the fluctuation of the resin pressure at the die within the range of ±1%.

To improve the fixed-amount feeding performance of the gear pump, a method can also be used in which the pressure before the gear pump is controlled to be constant by varying the number of revolution of the screw. Or the use of a high-precision gear pump is also effective in which three or more gears are used to eliminate the fluctuation in gear of a gear pump.

Other advantages of using a gear pump are such that it makes possible the film formation while reducing the pressure at the tip of the screw, which would be expected to reduce the energy consumption, prevent the increase in resin temperature, improve the transportation efficiency, decrease in the residence time of the resin in the extruder, and decrease the L/D of the extruder. Furthermore, when a filter is used to remove contaminants, if a gear pump is not used, the amount of the resin fed from the screw can sometimes vary with increase in filtration pressure. However, this variation in the amount of resin fed from the screw can be eliminated by using a gear pump. On the other hand, disadvantages of using a gear pump are such that: it may increase the length of the equipment used, depending on the selection of equipment, which results in a longer residence time of the resin in the equipment; and the shear stress generated at the gear pump portion may cause the breakage of molecule chains. Thus, care must be taken when using a gear pump.

Preferably, the residence time of the resin, from the time the resin enters the extruder through the feed opening to the time it goes out of the die, is 2 minutes or longer and 60 minutes or shorter, more preferably 3 minutes or longer and 40 minutes or shorter, and much more preferably 4 minutes or longer and 30 minutes or shorter.

If the flow of polymer circulating around the bearing of the gear pump is not smooth, the seal by the polymer at the driving portion and the bearing portion becomes poor, which may cause the problem of producing wide fluctuations in measurements and feeding and extruding pressures. Thus, the gear pump (particularly clearances thereof) should be designed to match to the melt viscosity of the saturated norbornene resin. In some cases, the portion of the gear pump where the saturated norbornene resin resides can be a cause of the resin's deterioration. Thus, preferably the gear pump has a structure which allows the residence time of the saturated norbornene resin to be as short as possible. The polymer tubes or adaptors that connect the extruder with a gear pump or a gear pump with the die should be so designed that they allow the residence time of the saturated norbornene resin to be as short as possible. Furthermore, to stabilize the extrusion pressure of the saturated norbornene resin whose melt viscosity is highly temperature-dependent, preferably the fluctuation in temperature is kept as narrow as possible. Generally, a band heater, which requires lower equipment costs, is often used for heating polymer tubes; however, it is more preferable to use a cast-in aluminum heater which is less susceptible to temperature fluctuation. Further, to allow G′, G″, tan δ, η to have the maximum and the minimum in the extruder as described above, it is preferable to melt the saturated norbornene resin by heating the barrel of the extruder with heater divided into 3 or more and 20 or less.

### (iv) Die

With the extruder constructed as above, the saturated norbornene resin is melted and continuously fed into a die, if necessary, through a filter or gear pump. Any type of commonly used die, such as T-die, fish-tail die or hanger coat die, may be used, as long as it allows the residence time of the molten resin to be short. Further, a static mixer can be introduced right before the T-die to increase the temperature uniformity. The clearance at the outlet of the T-die can be 1.0 to 5.0 times the film thickness, preferably 1.2 to 3 times the film thickness, and more preferably 1.3 to 2 times the film thickness. If the lip clearance is less than 1.0 time the film thickness, it is difficult to obtain a sheet whose surface state is good. Conversely, if the lip clearance is more than 5.0 times the film thickness, undesirably the thickness precision of the sheet is decreased. A die is very important equipment which determines the thickness precision of the film to be formed, and thus, one that can severely control the film thickness is preferably used. Although commonly used dies can control the film thickness at intervals of 40 to 50 mm, dies of a type which can control the film thickness at intervals of 35 mm or less and more preferably at intervals of 25 mm or less are preferable. In the saturated norbornene resin, since its melt viscosity is highly temperature-dependent and shear-rate-dependent, it is important to design a die that causes the least possible temperature uniformity and the least possible flow-rate uniformity across the width. The use of an automated thickness adjusting die, which measures the thickness of the film downstream, calculates the thickness deviation and feeds the calculated result back to the thickness adjustment, is also effective in decreasing fluctuations in thickness in the long-term continuous production of the saturated norbornene resin film.

In producing films, a single-layer film forming apparatus, which requires lower manufacturing costs, is generally used. However, depending on the situation, it is also possible to use a multi-layer film forming apparatus to produce a film having 2 types or more of structure, in which an outer layer is formed as a functional layer. Generally, preferably a functional layer is laminated thin on the surface of the saturated norbornene resin film, but the layer-layer ratio is not limited to any specific one.

### (v) Cast

The molten resin extruded in the form of a sheet from the die in the above described manner is cooled and solidified on casting drums to obtain a film. In this cooling and solidifying operation, preferably the adhesion of the extruded sheet of the molten resin to the casting drums is enhanced by any of the methods, such as electrostatic application method, air-knife method, air-chamber method, vacuum-nozzle method or touch-roll method. These adhesion enhancing methods may be applied to either the whole surface or part of the surface of the sheet resulting from melt extrusion. A method, called as edge pinning, in which casting drums are adhered to the edges of the film alone is often employed, but the adhesion enhancing method used in the present invention is not limited to this method.

Preferably the sheet of the molten resin is cooled little by little using a plurality of casting drums. Generally, cooling is often carried out using three cooling rolls; however, the number of the cooling rolls used is not limited to 3. The diameter of the rolls is preferably 50 mm to 5000 mm, more preferably 100 mm to 2000 mm, and much more preferably 150 mm to 1000 mm. The spacing between the two adjacent rolls is preferably 0.3 mm to 300 mm, on a face-to-face base, more preferably 1 mm to 100 mm, and much more preferably 3 mm to 30 mm.

The temperature of casting drums is preferably 60° C. or higher and 160° C. or lower, more preferably 70° C. or higher and 150° C. or lower, and much more preferably 80° C. or higher and 140° C. or lower. The cooled and solidified sheet is then stripped off from the casting drums, passed through take-off rollers (a pair of nip rollers), and wound up. The wind-up speed is preferably 10 m/min or higher and 100 m/min or lower, more preferably 15 m/min or higher and 80 m/min or lower, and much more preferably 20 m/min or higher and 70 m/min or lower.

The width of the film thus formed is preferably 0.7 m or more and 5 m or less, more preferably 1 m or more and 4 m or less, and much more preferably 1.3 m or more and 3 m or less. The thickness of the unstretched film thus obtained is preferably 30 μm or more and 400 μm or less, more preferably 40 μm or more and 300 μm or less, and much more preferably 50 μm or more and 200 μm or less.

The thickness non-uniformity of the formed saturated norbornene film is preferably 0% to 2% in both the longitudinal and the transverse directions, more preferably 0% to 1.5%, and much more preferably 0% to 1%. The saturated norbornene film thus formed is then stretched by the above described method to obtain a saturated norbornene film of the present invention. When so-called touch roll method is used, the surface of the touch roll used may be made of resin, such as rubber or Teflon, or metal. A roll, called as flexible roll, can also be used whose surface gets a little depressed by the pressure of a metal roll having a decreased thickness when the flexible roll and the metal roll touch with each other, and their pressure contact area is increased.

The temperature of the touch roll is preferably 60° C. or higher and 160° C. or lower, more preferably 70° C. or higher and 150° C. or lower, and much more preferably 80° C. or higher and 140° C. or lower.

### (vi) Winding Up

Preferably, the sheet thus obtained is wound up with its edges trimmed away. The portions having been trimmed off may be reused as a raw material for the same kind of film or a different kind of film, after undergoing grinding or after undergoing granulation, or depolymerization or re-polymerization depending on the situation. Any type of trimming cutter, such as a rotary cutter, shearing blade or knife, may be used. The material of the cutter may be either carbon steel or stainless steel. Generally, a carbide-tipped blade or ceramic blade is preferably used, because use of such a blade makes the life of a cutter longer and suppresses the production of cuttings.

It is also preferable, from the viewpoint of preventing the occurrence of scratches on the sheet, to provide, prior to winding up, a laminating film at least on one side of the sheet. Preferably, the wind-up tension is 1 kg/m (in width) or higher and 50 kg/m (in width) or lower, more preferably 2 kg/m (in width) or higher and 40 kg/m (in width) or lower, and much more preferably 3 kg/m (in width) or higher and 20 kg/m (in width) or lower. If the wind-up tension is lower than 1 kg/m (in width), it is difficult to wind up the film uniformly. Conversely, if the wind-up tension is higher than 50 kg/m (in width), undesirably the film is too tightly wound, whereby the appearance of wound film deteriorates, and the knot portion of the film is stretched due to the creep phenomenon, causing surging in the film, or residual double refraction occurs due to the extension of the film. Preferably, the winding up is performed while detecting the wind-up tension with a tension control provided midway along the line and controlling the same to be constant. When there is a difference in the film temperature depending on the spot on the film forming line, a slight difference in the film length can sometimes be created due to thermal expansion, and thus, it is necessary to adjust the draw ratio of the nip rolls so that tension higher than a prescribed one should not be applied to the film.

Preferably, the winding up of the film is performed while tapering the amount of the film to be wound according to the winding diameter so that a proper wind-up tension is kept, though it can be performed while keeping the wind-up tension constant by the control with the tension control. Generally, the wind-up tension is decreased little by little with increase in the winding diameter; however, it can sometimes be preferable to increase the wind-up tension with increase in the winding diameter.

The above winding method is a typical method in which the heat treatment of the present invention is performed off-line. When the heat treatment of the invention is performed on-line, winding must be controlled as described above.

Such a winding method is also applicable to the solution film forming method described below.

### (Solution Film Formation)

When the saturated norbornene resin of the present invention is dissolved in a solvent, the concentration of the resin in the solution is preferably 3 to 50% by weight, more preferably 5 to 40% by weight, and much more preferably 10 to 35% by weight. The viscosity of such a solution at room temperature is usually 1 to 1,000,000 (mPa·s), preferably 10 to 100,000 (mPa·s), more preferably 100 to 50,000 (mPa·s), and particularly preferably 1,000 to 40,000 (mPa·s).

Examples of solvent applicable include: aromatic solvents such as benzene, toluene and xylene; cellosolve solvents such as methyl cellosolve, ethyl cellosolve and 1-methoxy-2-propanol; ketone solvents such as diacetone alcohol, acetone, cyclohexanone, methyl ethyl ketone, 4-methyl-2-pentanone, cyclohexanone, ethyl cyclohexanone and 1,2-dimethylcyclohexane; ester solvents such as methyl lactate and ethyl lactate; halogen-containing solvents such as 2,2,3,3-tetrafluoro-1-propanol, methylene chloride and chloroform; ether solvents such as tetrahydrofuran and dioxane; alcohol solvents such as 1-pentanol and 1-butanol.

Solvents other than the above described ones may be used whose SP values (solubility parameter) are usually in the range of 10 to 30 (MPa1/2), preferably in the range of 10 to 25 (MPa1/2), more preferably in the range of 15 to 25 (MPa1/2), and particularly preferably in the range of 15 to 20 (MPa1/2). Either one of the above described solvents alone or two or more kinds of them together can be used. When two or more kinds of solvents are used together, it is preferable to allow the SP value of the mixture to fall in the above described range. The SP value of a mixture can be obtained from the weight ratio of one kind of solvent to the other. In case of a mixture of two kinds of solvents, for example, the SP value of the mixture can be calculated using the following equation:

SP value=W1·SP1+W2·SP2

where W1, W2 represent the weight fractions of the respective solvents and SP1, SP2 represent the SP values of the respective solvents.

A leveling agent can also be added to improve the surface smoothness of the saturated norbornene film. Any leveling agents can be used, as long as they are commonly-used-type ones. Examples of leveling agents applicable include: fluorine-type nonionic surfactants, special acrylic resin-type leveling agents, and silicone-type leveling agents.

Commonly used methods of producing the saturated norbornene film of the present invention by solvent casting process include: for example, a method including the steps of: applying the above described solution onto a substrate such as a metal drum, steel belt, polyester film of polyethylene terephthalate (PET) or polyethylene naphthalate (PEN), or polytetrafluoroethylene belt; drying and removing the solvent; and stripping off the film.

The saturated norbornene film of the present invention can also be produced by: applying the resin solution to a substrate using means, such as spray, brush, roll spin coat or dipping; drying and removing the solvent; and stripping off the film from the substrate. The application of the resin solution may be repeated to control the thickness or the surface smoothness of the film.

When a polyester film is used as a substrate, such a polyester film may have undergone surface treatment before using. Methods of such surface treatment include: commonly used hydrophilization treatment; a method in which, for example, acrylic resin or sulfonate-group-containing resin is applied or stacked by lamination on the polyester film; or a method in which the polyester film undergoes corona discharge treatment etc. so that the hydrophilicity of the film surface is improved.

The above described solvent casting process can employ any of commonly used drying (solvent removing) processes. For example, drying can be carried out by a process in which the film is passed through a drying furnace via a number of rollers. However, if air bubbles are generated, during the drying process, with the evaporation of the solvent, the properties of the film significantly deteriorate. Thus, in order to avoid this, it is preferable to allow the drying process to include two or more steps and control the temperature and amount of the air used for each step.

The amount of the residual solvent in an optical film is usually 10% by weight or less, preferably 5% by weight or less, more preferably 1% by weight or less, and particularly preferably 0.5% by weight or less. Decreasing the amount of the residual solvent is preferable, because it allows trouble of adhesive traces to be further reduced.

The thickness of the saturated norbornene film of the present invention is preferably 10 to 300 μm, more preferably 20 to 250 μm, and much more preferably 30 to 200 μm. The thickness distribution is preferably within ±8% relative to the average value, more preferably within ±5%, and much more preferably within ±3%. The variation in thickness per cm is usually 5% or less, preferably 3% or less, more preferably 1% or less, and particularly preferably 0.5% or less.

### (Processing of Saturated Norbornene Film)

The saturated norbornene film having undergone uniaxial stretching or biaxial stretching by the above described method may be used independently or in combination with a polarizing plate. Or it may also be used with its surface provided with a liquid crystal layer or a layer whose refractive index has been controlled (low reflection layer) or a hard coat layer. These films can be achieved by carrying out the following steps.

### (i) Surface Treatment

The adhesion of both unstretched and stretched saturated norbornene resin films to each functional layer (e.g. undercoat layer and back layer) can be improved by subjecting them to surface treatment. Examples of types of surface treatment applicable include: treatment using glow discharge, ultraviolet irradiation, corona discharge, flame, or acid or alkali. The glow discharge treatment mentioned herein may be treatment using low-temperature plasma generated in a low-pressure gas at 10⁻³ to 20 Torr. Or plasma treatment at atmospheric pressure is also preferable. Plasma excitation gases are gases that undergo plasma excitation under the above described conditions, and examples of such gases include: argon, helium, neon, krypton, xenon, nitrogen, carbon dioxide, flons such as tetrafluoromethane, and the mixtures thereof. These are described in detail in Journal of Technical Disclosure (Laid-Open No. 2001-1745, issued on Mar. 15, 2001, by Japan Institute of Invention and Innovation), 30-32. In the plasma treatment at atmospheric pressure, which has attracted considerable attention in recent years, for example, irradiation energy of 20 to 500 Kgy is used at 10 to 1000 Kev, and preferably irradiation energy of 20 to 300 Kgy is used at 30 to 500 Kev.

Of these types of surface treatment, particularly preferable are glow discharge treatment, corona discharge treatment and flame treatment.

To improve the adhesion of the unstretched or stretched saturated norbornene resin film to each functional layer, it is preferable to provide an undercoat layer on the saturated norbornene resin film. The undercoat layer may be provided after carrying out the above described surface treatment or without the surface treatment. The details of the undercoat layers are described in Journal of Technical Disclosure (Laid-Open No. 2001-1745, issued on Mar. 15, 2001, by Japan Institute of Invention and Innovation), 32.

These surface-treatment step and under-coat step can be incorporated into the final part of the film forming step, or they can be performed independently, or they can be performed in the functional-layer providing process.

### (ii) Providing Functional Layer

Preferably, the stretched and unstretched saturated norbornene resin films of the present invention are combined with any one of the functional layers described in detail in Journal of Technical Disclosure (Laid-Open No. 2001-1745, issued on Mar. 15, 2001, by Japan Institute of Invention and Innovation), 32-45. Particularly preferable is providing a polarizing layer (polarizer), optical compensation layer (optical compensation film), antireflection layer (antireflection film) or hard coat layer.

### (a) Providing Polarizing Layer (Preparation of Polarizer)

(a-1) Materials Used for Polarizing Layer

At the present time, generally, commercially available polarizing layers are prepared by immersing stretched polymer in a solution of iodine or a dichroic dye in a bath so that the iodine or dichroic dye penetrates into the binder. Coating-type of polarizing films, represented by those manufactured by Optiva Inc., are also available as a polarizing film. Iodine or a dichroic dye in the polarizing film develops polarizing properties when its molecules are oriented in a binder. Examples of dichroic dyes applicable include: azo dye, stilbene dye, pyrazolone dye, triphenylmethane dye, quinoline dye, oxazine dye, thiazine dye and anthraquinone dye. The dichroic dye used is preferably water-soluble. The dichroic dye used preferably has a hydrophilic substitute (e.g. sulfo, amino, or hydroxyl). Example of such dichroic dyes includes: compounds described in Journal of Technical Disclosure, Laid-Open No. 2001-1745, 58, (issued on Mar. 15, 2001, by Japan Institute of Invention and Innovation).

Any polymer which is crosslinkable in itself or which is crosslinkable in the presence of a crosslinking agent can be used as a binder for polarizing films. And more than one combination thereof can also be used as a binder. Examples of binders applicable include: compounds described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000. Details of denatured polyvinyl alcohol are described in Japanese Patent Application Laid-Open Nos. 8-338913, 9-152509 and 9-316127. For polyvinyl alcohol and denatured polyvinyl alcohol, two or more kinds may be used in combination.

Preferably, the minimum of the binder thickness is 10 μm. For the maximum of the binder thickness, from the viewpoint of light leakage of liquid crystal displays, preferably the binder has the smallest possible thickness. The thickness of the binder is preferably equal to or smaller than that of currently commercially available polarizer (about 30 μm), more preferably 25 μm or smaller, and much more preferably 20 μm or smaller.

The binder for polarizing films may be crosslinked. Polymer or monomer that has a crosslinkable functional group may be mixed into the binder. Or a crosslinkable functional group may be provided to the binder polymer itself. Crosslinking reaction is allowed to progress by use of light, heat or pH changes, and a binder having a crosslinked structure can be formed by crosslinking reaction. Examples of crosslinking agents applicable are described in U.S. Pat. (Reissued) No. 23,297. Boron compounds (e.g. boric acid and borax) may also be used as a crosslinking agent. The amount of the crosslinking agent added to the binder is preferably 0.1 to 20% by mass of the binder. This allows polarizing devices to have good orientation characteristics and polarizing films to have good damp heat resistance.

The amount of the unreacted crosslinking agent after completion of the crosslinking reaction is preferably 1.0% by mass or less and more preferably 0.5% by mass or less. Restraining the unreacted crosslinking agent to such an amount improves the weatherability of the binder.

(a-2) Stretching of Polarizing Film

Preferably, a polarizing film is dyed with iodine or a dichroic dye after undergoing stretching (stretching process) or rubbing (rubbing process).

In the stretching process, preferably the stretching magnification is 2.5 to 30.0 and more preferably 3.0 to 10.0. Stretching can be dry stretching, which is performed in the air. Stretching can also be wet stretching, which is performed while immersing a film in water. The stretching magnification in the dry stretching is preferably 2.5 to 5.0, while the stretching magnification in the wet stretching is preferably 3.0 to 10.0. Stretching may be performed parallel to the MD direction (parallel stretching) or in an oblique (oblique stretching). These stretching operations may be performed at one time or in several installments. Stretching can be performed more uniformly even in high-ratio stretching if it is performed in several installments.

### (I) Parallel Stretching Process

Prior to stretching, a PVA film is swelled. The degree of swelling is 1.2 to 2.0 (ratio of mass before swelling to mass after swelling). After this swelling operation, the PVA film is stretched in a water-based solvent bath or in a dye bath in which a dichroic substance is dissolved at a bath temperature of 15 to 50° C., preferably 17 to 40° C. while continuously conveying the film via a guide roll etc. Stretching can be accomplished in such a manner as to grip the PVA film with 2 pairs of nip rolls and control the conveying speed of nip rolls so that the conveying speed of the latter pair of nip rolls is higher than that of the former pair of nip rolls. The stretching magnification is based on the length of PVA film after stretching/the length of the same in the initial state ratio (hereinafter the same), and from the viewpoint of the above described advantages, the stretching magnification is preferably 1.2 to 3.5 and more preferably 1.5 to 3.0. After this stretching operation, the film is dried at 50° C. to 90° C. to obtain a polarizing film.

### (II) Oblique Stretching Process

Oblique stretching can be performed by the method described in Japanese Patent Application Laid-Open No. 2002-86554 in which a tenter that projects on a tilt is used. This stretching is performed in the air; therefore, it is necessary to allow a film to contain water so that the film is easy to stretch. Preferably, the water content in the film is 5% or higher and 100% or lower.

The temperature during the stretching is preferably 40° C. to 90° C. and more preferably 50° C. to 80° C. The humidity is preferably 50% rh to 100% rh, more preferably 70% rh to 100% rh, and much more preferably 80% rh to 100% rh. The traveling speed of the film across the length is preferably 1 m/min or higher and more preferably 3 m/min or higher.

After completing the stretching, the film was dried at 50° C. to 100° C. and preferably 60° C. to 90° C. for 0.5 minutes to 10 minutes and more preferably 1 minute to 5 minutes.

The absorbing axis of the polarizing film thus obtained is preferably 10 degrees to 80 degrees, more preferably 30 degrees to 60 degrees, and much more preferably substantially 45 degrees (40 degrees to 50 degrees).

(a-3) Adhesion

The above described saturated norbornene film having undergone surface treatment and the polarizing layer prepared through stretching are adhered together to prepare a polarizing plate. Preferably the adhesion is performed so that the angle between the axis in the direction of the saturated norbornene film casting and the axis in the direction of the polarizing plate stretching is 45 degrees.

Examples of adhesives used for the adhesion include: not limited to, PVA resins (including modified PVAs such as acetoacetyl, sulfonic, carboxyl and oxyalkylene groups); aqueous solutions of boron compounds; and epoxy adhesives. Of these adhesives, PVA resins and epoxy adhesives are preferable. The thickness of the adhesive layer, on a dried basis, is preferably 0.01 to 10 μm and particularly preferably 0.05 to 5 μm.

Preferably, the sheets of polarizer thus obtained have a high light transmittance and a high degree of polarization. The light transmittance of the polarizer is preferably in the range of 30 to 50% at a wavelength of 550 nm, more preferably in the range of 35 to 50%, and most preferably in the range of 40 to 50%. The degree of polarization is preferably in the range of 90 to 100% at a wavelength of 550 nm, more preferably in the range of 95 to 100%, and most preferably in the range of 99 to 100%.

The sheets of polarizer thus obtained can be laminated with a λ/4 plate to create circularly polarized light. In this case, they are laminated so that the angle between the slow axis of the λ/4 plate and the absorbing axis of the polarizer is 45 degrees. Any λ/4 plate can be used to create circularly polarized light; however, preferably one having such wavelength-dependency that retardation is decreased with decrease in wavelength is used. More preferably, a polarizing film having an absorbing axis which tilts 20 degrees to 70 degrees in the longitudinal direction and a λ/4 plate that includes an optically anisotropic layer made up of a liquid crystalline compound are used.

### (b) Providing Optical Compensation Layer (Preparation of Optical Compensation Film)

An optically anisotropic layer is used for compensating the liquid crystalline compound in a liquid crystal cell in black display by a liquid crystal display. It is prepared by forming an orientation film on each of the stretched and unstretched saturated norbornene resin films and providing an optically anisotropic layer on the orientation film.

(b-1) Orientation Film

An orientation film is provided on the above described stretched and unstretched saturated norbornene resin films which have undergone surface treatment. This film has the function of specifying the orientation direction of liquid crystalline molecules. However, this film is not necessarily indispensable constituent of the present invention. This is because a liquid crystalline compound plays the role of the orientation film, as long as the aligned state of the liquid crystalline compound is fixed after it undergoes orientation treatment. In other words, the sheets of polarizer of the present invention can also be prepared by transferring only the optically anisotropic layer on the orientation film, where the orientation state is fixed, on the polarizer.

An orientation film can be provided using a technique such as rubbing of an organic compound (preferably polymer), oblique deposition of an inorganic compound, formation of a micro-groove-including layer, or built-up of an organic compound (e.g. ω-tricosanic acid, dioctadecyl methyl ammonium chloride, methyl stearate) by Langmur-Blodgett technique (LB membrane). Orientation films in which orientation function is produced by the application of electric field, electromagnetic field or light irradiation are also known.

Preferably, the orientation film is formed by rubbing of polymer. As a general rule, the polymer used for the orientation film has a molecular structure having the function of aligning liquid crystalline molecules.

In the present invention, preferably the orientation film has not only the function of aligning liquid crystalline molecules, but also the function of combining a side chain having a crosslinkable functional group (e.g. double bond) with the main chain or the function of introducing a crosslinkable functional group having the function of aligning liquid crystalline molecules into a side chain.

Either polymer which is crosslinkable in itself or polymer which is crosslinkable in the presence of a crosslinking agent can be used for the orientation film. And a plurality of the combinations thereof can also be used. Examples of such polymer include: those described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000.

Side chains having the function of aligning liquid crystal molecules generally have a hydrophobic group as a functional group. The kind of the functional group is determined depending on the kind of liquid crystalline molecules and the aligned state required.

For example, a denatured group of denatured polyvinyl alcohol can be introduced by copolymerization denaturation, chain transfer denaturation or block polymerization denaturation. Examples of denatured groups include: hydrophilic groups (e.g. carboxylic, sulfonic, phosphonic, amino, ammonium, amide and thiol groups); hydrocarbon groups with 10 to 100 carbon atoms; fluorine-substituted hydrocarbon groups; thioether groups; polymerizable groups (e.g. unsaturated polymerizable groups, epoxy group, azirinyl group); and alkoxysilyl groups (e.g. trialkoxy, dialkoxy, monoalkoxy). Specific examples of these denatured polyvinyl alcohol compounds include: those described in Japanese Patent Application Laid-Open No. 2000-155216, columns [0022] to [0145], Japanese Patent Application Laid-Open No. 2002-62426, columns [0018] to [0022].

Combining a side chain having a crosslinkable functional group with the main chain of the polymer of an orientation film or introducing a crosslinkable functional group into a side chain having the function of aligning liquid crystal molecules makes it possible to copolymerize the polymer of the orientation film and the polyfunctional monomer contained in the optically anisotropic layer. As a result, not only the molecules of the polyfunctional monomer, but also the molecules of the polymer of the orientation film and those of the polyfunctional monomer and the polymer of the orientation film are covalently firmly bonded together. Thus, introduction of a crosslinkable functional group into the polymer of an orientation film enables remarkable improvement in the strength of optical compensation films.

The crosslinkable functional group of the polymer of the orientation film preferably has a polymerizable group, like the polyfunctional monomer. Specific examples of such crosslinkable functional groups include: those described in Japanese Patent Application Laid-Open No. 2000-155216, columns [0080] to [0100]. The polymer of the orientation film can be crosslinked using a crosslinking agent, besides the above described crosslinkable functional groups.

Examples of crosslinking agents applicable include: aldehyde; N-methylol compounds; dioxane derivatives; compounds that function by the activation of their carboxyl group; activated vinyl compounds; activated halogen compounds; isoxazol; and dialdehyde starch. Two or more kinds of crosslinking agents may be used in combination. Specific examples of such crosslinking agents include: compounds described in Japanese Patent Application Laid-Open No. 2002-62426, columns [0023] to [0024]. Aldehyde, which is highly reactive, particularly glutaraldehyde is preferably used as a crosslinking agent.

The amount of the crosslinking agent added is preferably 0.1 to 20% by mass of the polymer and more preferably 0.5 to 15% by mass. The amount of the unreacted crosslinking agent remaining in the orientation film is preferably 1.0% by mass or less and more preferably 0.5% by mass or less. Controlling the amount of the crosslinking agent and unreacted crosslinking agent in the above described manner makes it possible to obtain a sufficiently durable orientation film, in which reticulation does not occur even after it is used in a liquid crystal display for a long time or it is left in an atmosphere of high temperature and high humidity for a long time.

Basically, an orientation film can be formed by: coating the above described polymer, as a material for forming an orientation film, on a transparent substrate containing a crosslinking agent; heat drying (crosslinking) the polymer; and rubbing the same. The crosslinking reaction may be carried out at any time after the polymer is applied to the transparent substrate, as described above. When a water-soluble polymer, such as polyvinyl alcohol, is used as the material for forming an orientation film, the coating solution is preferably a mixed solvent of an organic solvent having an anti-foaming function (e.g. methanol) and water. The mixing ratio is preferably such that water:methanol=0:100 to 99:1 and more preferably 0:100 to 91:9. The use of such a mixed solvent suppresses the generation of foam, thereby significantly decreasing defects not only in the orientation film, but also on the surface of the optically anisotropic layer.

As a coating method for coating an orientation film, spin coating, dip coating, curtain coating, extrusion coating, rod coating or roll coating is preferably used. Particularly preferably used is rod coating. The thickness of the film after drying is preferably 0.1 to 10 μm. The heat drying can be carried out at 20° C. to 110° C. To achieve sufficient crosslinking, preferably the heat drying is carried out at 60° C. to 100° C. and particularly preferably at 80° C. to 100° C. The drying time can be 1 minute to 36 hours, but preferably it is 1 minute to 30 minutes. Preferably, the pH of the coating solution is set to a value optimal to the crosslinking agent used. When glutaraldehyde is used, the pH is 4.5 to 5.5 and particularly preferably 5.

The orientation film is provided on the stretched and unstretched transparent substrate or on the above described undercoat layer. The orientation film can be obtained by crosslinking the polymer layer and providing rubbing treatment on the surface of the polymer layer, as described above.

The above described rubbing treatment can be carried out using a treatment method widely used in the treatment of liquid crystal orientation in LCD. Specifically, orientation can be obtained by rubbing the surface of the orientation film in a fixed direction with paper, gauze, felt, rubber or nylon, polyester fiber and the like. Generally the treatment is carried out by repeating rubbing a several times using a cloth in which fibers of uniform length and diameter have been uniformly transplanted.

In the rubbing treatment industrially carried out, rubbing is performed by bringing a rotating rubbing roll into contact with a running film including a polarizing layer. The circularity, cylindricity and deviation (eccentricity) of the rubbing roll are preferably 30 μm or less respectively. The wrap angle of the film wrapping around the rubbing roll is preferably 0.1 to 90°. However, as described in Japanese Patent Application Laid-Open No. 8-160430, if the film is wrapped around the rubbing roll at 360° or more, stable rubbing treatment is ensured. The conveying speed of the film is preferably 1 to 100 m/min. Preferably, the rubbing angle is properly selected from the range of 0 to 60°. When the orientation film is used in liquid crystal displays, the rubbing angle is preferably 40° to 50° and particularly preferably 45°. The thickness of the orientation film thus obtained is preferably in the range of 0.1 to 10 μm.

Then, liquid crystalline molecules of the optically anisotropic layer are aligned on the orientation film. After that, if necessary, the polymer of the orientation film and the polyfunctional monomer contained in the optically anisotropic layer are reacted, or the polymer of the orientation film is crosslinked using a crosslinking agent.

The liquid crystalline molecules used for the optically anisotropic layer include: rod-shaped liquid crystalline molecules and discotic liquid crystalline molecules. The rod-shaped liquid crystalline molecules and discotic liquid crystalline molecules may be either high-molecular-weight liquid crystalline molecules or low-molecular-weight liquid crystalline molecules, and they include low-molecule liquid crystalline molecules which have undergone crosslinking and do not show liquid crystallinity any more.

(b-2) Rod-Shaped Liquid Crystalline Molecules

Examples of rod-shaped liquid crystalline molecules preferably used include: azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

Rod-shaped liquid crystalline molecules also include metal complexes. Liquid crystal polymer that includes rod-shaped liquid crystalline molecules in its repeating unit can also be used as rod-shaped liquid crystalline molecules. In other words, rod-shaped liquid crystalline molecules may be bonded to (liquid crystal) polymer.

Rod-shaped liquid crystalline molecules are described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Handbook of Liquid Crystal Devices, edited by 142th Committee of Japan Society for the Promotion of Science, Chapter 3.

The index of birefringence of the rod-shaped liquid crystalline molecules is preferably in the range of 0.001 to 0.7. To allow the aligned state to be fixed, preferably the rod-shaped liquid crystalline molecules have a polymerizable group. As such a polymerizable group, a radically polymerizable unsaturated group or cationically polymerizable group is preferable. Specific examples of such polymerizable groups include: polymerizable groups and polymerizable liquid crystal compounds described in Japanese Patent Application Laid-Open No. 2002-62427, columns [0064] to [0086].

(b-3) Discotic Liquid Crystalline Molecules

Discotic liquid crystalline molecules include: benzene derivatives described in the research report by C. Destrade et al., Mol. Cryst. Vol. 71, 111 (1981); truxene derivatives described in the research report by C. Destrade et al., Mol. Cryst. Vol. 122, 141 (1985) and Physics lett, A, Vol. 78, 82 (1990); cyclohexane derivatives described in the research report by B. Kohne et al., Angew. Chem. Vol. 96, 70 (1984); and azacrown or phenylacetylene macrocycles described in the research report by J. M. Lehn et al., J. Chem. Commun., 1794 (1985) and in the research report by J. Zhang et al., L. Am. Chem. Soc. Vol. 116, 2655 (1994).

Discotic liquid crystalline molecules also include liquid crystalline compounds having a structure in which straight-chain alkyl group, alkoxy group and substituted benzoyloxy group are substituted radially as the side chains of the mother nucleus at the center of the molecules. Preferably, the compounds are such that their molecules or groups of molecules have rotational symmetry and they can provide an optically anisotropic layer with a fixed orientation. In the ultimate state of the optically anisotropic layer formed of discotic liquid crystalline molecules, the compounds contained in the optically anisotropic layer are not necessarily discotic liquid crystalline molecules. The ultimate state of the optically anisotropic layer also contain compounds such that they are originally of low-molecular-weight discotic liquid crystalline molecules having a group reactive with heat or light, but undergo polymerization or crosslinking by heat or light, thereby becoming higher-molecular-weight molecules and losing their liquid crystallinity. Examples of preferred discotic liquid crystalline molecules are described in Japanese Patent Application Laid-Open No. 8-50206. And the details of the polymerization of discotic liquid crystalline molecules are described in Japanese Patent Application Laid-Open No. 8-27284.

To fix the discotic liquid crystalline molecules by polymerization, it is necessary to bond a polymerizable group, as a substitute, to the discotic core of the discotic liquid crystalline molecules. Compounds in which their discotic core and a polymerizable group are bonded to each other via a linking group are preferably used. With such compounds, the aligned state is maintained during the polymerization reaction. Examples of such compounds include: those described in Japanese Patent Application Laid-Open No. 2000-155216, columns [0151] to [0168].

In hybrid orientation, the angle between the long axis (disc plane) of the discotic liquid crystalline molecules and the plane of the polarizing film increases or decreases, across the depth of the optically anisotropic layer, with increase in the distance from the plane of the polarizing film. Preferably, the angle decreases with increase in the distance. The possible changes in angle include: continuous increase, continuous decrease, intermittent increase, intermittent decrease, change including both continuous increase and continuous decrease, and intermittent change including increase and decrease. The intermittent changes include the area midway across the thickness where the tilt angle does not change. Even if the change includes the area where the angle does not change, it does not matter as long as the angle increases or decreased as a whole. Preferably, the angle changes continuously.

Generally, the average direction of the long axis of the discotic liquid crystalline molecules on the polarizing film side can be adjusted by selecting the type of discotic liquid crystalline molecules or the material for the orientation film, or by selecting the method of rubbing treatment. On the other hand, generally the direction of the long axis (disc plane) of the discotic liquid crystalline molecules on the surface side (on the air side) can be adjusted by selecting the type of discotic liquid crystalline molecules or the type of the additives used together with the discotic liquid crystalline molecules. Examples of additives used with the discotic liquid crystalline molecules include: plasticizer, surfactant, polymerizable monomer, and polymer. The degree of the change in orientation in the long axis direction can also be adjusted by selecting the type of the liquid crystalline molecules and that of additives, like the above described cases.

(b-4) Other Compositions of Optically Anisotropic Layer

Use of plasticizer, surfactant, polymerizable monomer, etc. together with the above described liquid crystalline molecules makes it possible to improve the uniformity of the coating film, the strength of the film and the orientation of liquid crystalline molecules. Preferably, such additives are compatible with the liquid crystalline molecules, and they can change the tilt angle of the liquid crystalline molecules or do not inhibit the orientation of the liquid crystalline molecules.

Examples of polymerizable monomers applicable include radically polymerizable or cationically polymerizable compounds. Preferable are radically polymerizable polyfunctional monomers which are copolymerizable with the above described polymerizable-group containing liquid crystalline compounds. Specific examples are those described in Japanese Patent Application Laid-Open No. 2002-296423, columns [0018] to [0020]. The amount of the above described compounds added is generally in the range of 1 to 50% by mass of the discotic liquid crystalline molecules and preferably in the range of 5 to 30% by mass.

Examples of surfactants include traditionally known compounds; however, fluorine compounds are particularly preferable. Specific examples of fluorine compounds include compounds described in Japanese Patent Application Laid-Open No. 2001-330725, columns [0028] to [0056].

Preferably, polymers used together with the discotic liquid crystalline molecules can change the tilt angle of the discotic liquid crystalline molecules.

Examples of polymers applicable include cellulose esters. Examples of preferred cellulose esters include those described in Japanese Patent Application Laid-Open No. 2000-155216, columns [0178]. Not to inhibit the orientation of the liquid crystalline molecules, the amount of the above described polymers added is preferably in the range of 0.1 to 10% by mass of the liquid crystalline molecules and more preferably in the range of 0.1 to 8% by mass.

The discotic nematic liquid crystal phase-solid phase transition temperature of the discotic liquid crystalline molecules is preferably 70 to 300° C. and more preferably 70 to 170° C.

(b-5) Formation of Optically Anisotropic Layer

An optically anisotropic layer can be formed by coating the surface of the orientation film with a coating fluid that contains liquid crystalline molecules and, if necessary, polymerization initiator or any other ingredients described later.

As a solvent used for preparing the coating fluid, an organic solvent is preferably used. Examples of organic solvents applicable include: amides (e.g. N,N-dimethylformamide); sulfoxides (e.g. dimethylsulfoxide); heterocycle compounds (e.g. pyridine); hydrocarbons (e.g. benzene, hexane); alkyl halides (e.g. chloroform, dichloromethane, tetrachloroethane); esters (e.g. methyl acetate, butyl acetate); ketones (e.g. acetone, methyl ethyl ketone); and ethers (e.g. tetrahydrofuran, 1,2-dimethoxyethane). Alkyl halides and ketones are preferably used. Two or more kinds of organic solvent can be used in combination.

Such a coating fluid can be applied by a known method (e.g. wire bar coating, extrusion coating, direct gravure coating, reverse gravure coating or die coating method).

The thickness of the optically anisotropic layer is preferably 0.1 to 20 μm, more preferably 0.5 to 15 μm, and most preferably 1 to 10 μm.

(b-6) Fixation of Orientation State of Liquid Crystalline Molecules

The aligned state of the aligned liquid crystalline molecules can be maintained and fixed. Preferably, the fixation is performed by polymerization. Types of polymerization include: heat polymerization using a heat polymerization initiator and photopolymerization using a photopolymerization initiator. For the fixation, photopolymerization is preferably used.

Examples of photopolymerization initiators include: α-carbonyl compounds (described in U.S. Pat. Nos. 2,367,661 and 2,367,670); acyloin ethers (described in U.S. Pat. No. 2,448,828); α-hydrocarbon-substituted aromatic acyloin compounds (U.S. Pat. No. 2,722,512); multi-nucleus quinone compounds (described in U.S. Pat. Nos. 3,046,127 and 2,951,758); combinations of triarylimidazole dimmer and p-aminophenyl ketone (described in U.S. Pat. No. 3,549,367); acridine and phenazine compounds (described in Japanese Patent Application Laid-Open No. 60-105667 and U.S. Pat. No. 4,239,850); and oxadiazole compounds (described in U.S. Pat. No. 4,212,970).

The amount of the photopolymerization initiators used is preferably in the range of 0.01 to 20% by mass of the solid content of the coating fluid and more preferably in the range of 0.5 to 5% by mass.

Light irradiation for the polymerization of liquid crystalline molecules is preferably performed using ultraviolet light.

Irradiation energy is preferably in the range of 20 mJ/cm² to 50 J/cm², more preferably 20 to 5000 mJ/cm², and much more preferably 100 to 800 mJ/cm². To accelerate the photopolymerization, light irradiation may be performed under heat. A protective layer may be provided on the surface of the optically anisotropic layer.

Combining the optical compensation film with a polarizing layer is also preferable. Specifically, an optically anisotropic layer is formed on a polarizing film by coating the surface of the polarizing film with the above described coating fluid for an optically anisotropic layer. As a result, thin polarlizer, in which stress generated with the dimensional change of polarizing film (distorsion×cross-sectional area×modulus of elasticity) is small, can be prepared without using a polymer film between the polarizing film and the optically anisotropic layer. Installing the polarizer according to the present invention in a large-sized liquid crystal display device enables high-quality images to be displayed without causing problems such as light leakage.

Preferably, stretching is performed while keeping the tilt angle of the polarizing layer and the optical compensation layer to the angle between the transmission axis of the two sheets of polarizer laminated on both sides of a liquid crystal cell constituting LCD and the longitudinal or transverse direction of the liquid crystal cell. Generally the tilt angle is 45°. However, in recent years, transmissive-, reflective-, and semi-transmissive-liquid crystal display devices have been developed in which the tilt angle is not always 45°, and thus, it is preferable to adjust the stretching direction arbitrarily to the design of each LCD.

(b-7) Liquid Crystal Display Devices

Liquid crystal modes in which the above described optical compensation film is used will be described.

### (TN-Mode Liquid Crystal Display Devices)

TN-mode liquid crystal display devices are most commonly used as a color TFT liquid crystal display device and described in a large number of documents. The aligned state in a TN-mode liquid crystal cell in the black state is such that the rod-shaped liquid crystalline molecules stand in the middle of the cell while the rod-shaped liquid crystalline molecules lie near the substrates of the cell.

### (OCB-Mode Liquid Crystal Display Devices)

An OCB-mode liquid crystal cell is a bend orientation mode liquid crystal cell where the rod-shaped liquid crystalline molecules in the upper part of the liquid cell and those in the lower part of the liquid cell are aligned in substantially opposite directions (symmetrically). Liquid crystal displays using a bend orientation mode liquid crystal cell are disclosed in U.S. Pat. Nos. 4,583,825 and 5,410,422. A bend orientation mode liquid crystal cell has a self-compensation function since the rod-shaped liquid crystalline molecules in the upper part of the liquid cell and those in the lower part are symmetrically aligned. Thus, this liquid crystal mode is also referred to as OCB

### (Optically Compensatory Bend) Liquid Crystal Mode.

Like in the TN-mode cell, the aligned state in an OCB-mode liquid crystal cell in the black state is also such that the rod-shaped liquid crystalline molecules stand in the middle of the cell while the rod-shaped liquid crystalline molecules lie near the substrates of the cell.

### (VA-Mode Liquid Crystal Display Devices)

VA-mode liquid crystal cells are characterized in that in the cells, rod-shaped liquid crystalline molecules are aligned substantially vertically when no voltage is applied. The VA-mode liquid crystal cells include: (1) a VA-mode liquid crystal cell in a narrow sense where rod-shaped liquid crystalline molecules are aligned substantially vertically when no voltage is applied, while they are aligned substantially horizontally when a voltage is applied (Japanese Patent Application Laid-Open No. 2-176625); (2) a MVA-mode liquid crystal cell obtained by introducing multi-domain switching of liquid crystal into a VA-mode liquid crystal cell to obtain wider viewing angle, (SID 97, Digest of Tech. Papers (Proceedings) 28 (1997) 845), (3) a n-ASM-mode liquid crystal cell where rod-shaped liquid crystalline molecules undergo substantially vertical orientation when no voltage is applied, while they undergo twisted multi-domain orientation when a voltage is applied (Proceedings 58 to 59 (1998), Symposium, Japanese Liquid Crystal Society); and (4) a SURVAIVAL-mode liquid crystal cell (reported in LCD international 98).

### (IPS-Mode Liquid Crystal Display Devices)

IPS-mode liquid crystal cells are characterized in that in the cells, rod-shaped liquid crystalline molecules are aligned substantially horizontally in plane when no voltage is applied and switching is performed by changing the orientation direction of the crystal in accordance with the presence or absence of application of voltage. Specific examples of IPS-mode liquid crystal cells applicable include those described in Japanese Patent Application Laid-Open Nos. 2004-365941, 2004-12731, 2004-215620, 2002-221726, 2002-55341 and 2003-195333.

### (Other-Mode Liquid Crystal Displays)

The above described optical compensation film is also applicable to ECB-mode and STN-mode liquid crystal displays, based on the same concept as described above.

(iii) Providing Antireflection Layer (Antireflection Film)

Generally an antireflection film is made up of: a low-refractive-index layer which also functions as a stainproof layer; and at least one layer having a refractive index higher than that of the low-refractive-index layer (i.e. high-refractive-index layer and/or intermediate-refractive-index layer) provided on a transparent substrate.

Methods of forming a multi-layer thin film as a laminate of transparent thin films of inorganic compounds (e.g. metal oxides) having different refractive indices include: chemical vapor deposition (CVD); physical vapor deposition (PVD); and a method in which a film of a colloid of metal oxide particles is formed by sol-gel process from a metal compound such as a metal alkoxide and the formed film is subjected to post-treatment (ultraviolet light irradiation: Japanese Patent Application Laid-Open No. 9-157855, plasma treatment: Japanese Patent Application Laid-Open No. 2002-327310).

On the other hand, there are proposed a various antireflection films, as highly productive antireflection films, which are formed by coating thin films of a matrix and inorganic particles dispersing therein in a laminated manner.

There is also provided an antireflection film including an antireflection layer provided with anti-glare properties, which is formed by using an antireflection film formed by coating as described above and providing the outermost surface of the film with fine irregularities.

The saturated norbornene resin film of the present invention is applicable to antireflection films formed by any of the above described methods, but particularly preferable is the antireflection film formed by coating (coating type antireflection film).

(c-1) Layer Configuration of Coating-Type Antireflection Film

An antireflection film having at least on its substrate a layer construction of: intermediate-refractive-index layer, high-refractive-index layer and low-refractive-index layer (outermost layer) in this order is designed to have a refractive index satisfying the following relationship.

Refractive index of high-refractive-index layer>refractive index of intermediate-refractive-index layer>refractive index of transparent substrate>refractive index of low-refractive-index layer, and a hard coat layer may be provided between the transparent substrate and the intermediate-refractive-index layer. The antireflection film may also be made up of: intermediate-refractive-index hard coat layer, high-refractive-index layer and low-refractive-index layer.

Examples of such antireflection films include: those described in Japanese Patent Application Laid-Open Nos. 8-122504, 8-110401, 10-300902, 2002-243906 and 2000-111706. Other functions may also be imparted to each layer. There are proposed, for example, antireflection films that include a stainproofing low-refractive-index layer or anti-static high-refractive-index layer (e.g. Japanese Patent Application Laid-Open Nos. 10-206603 and 2002-243906).

The haze of the antireflection film is preferably 5% or less and more preferably 3% or less. The strength of the film is preferably H or higher, by pencil hardness test in accordance with JIS K5400, more preferably 2H or higher, and most preferably 3H or higher.

(c-2) High-Refractive-Index Layer and Intermediate-Refractive-Index Layer

The layer of the antireflection film having a high refractive index consists of a curable film that contains: at least ultra-fine particles of high-refractive-index inorganic compound having an average particle size of 100 nm or less; and a matrix binder.

Fine particles of high-refractive-index inorganic compound include: for example, those of inorganic compounds having a refractive index of 1.65 or more and preferably 1.9 or more. Specific examples of such inorganic compounds include: oxides of Ti, Zn, Sb, Sn, Zr, Ce, Ta, La or In; and composite oxides containing these metal atoms.

Methods of forming such ultra-fine particles include: for example, treating the particle surface with a surface treatment agent (e.g. a silane coupling agent, Japanese Patent Application Laid-Open Nos. 11-295503, 11-153703, 2000-9908, an anionic compound or organic metal coupling agent, Japanese Patent Application Laid-Open No. 2001-310432 etc.); allowing particles to have a core-shell structure in which a core is made up of high-refractive-index particle(s) (Japanese Patent Application Laid-Open No. 2001-166104 etc.); and using a specific dispersant together (Japanese Patent Application Laid-Open No. 11-153703, U.S. Pat. No. 6,210,858B1, Japanese Patent Application Laid-Open No. 2002-2776069, etc.).

Materials used for forming a matrix include: for example, conventionally known thermoplastic resins and curable resin films.

Further, as such a material, at least one composition is preferable which is selected from the group consisting of: a composition including a polyfunctional compound that has at least two radically polymerizable and/or cationically polymerizable group; an organic metal compound containing a hydrolytic group; and a composition as a partially condensed product of the above organic metal compound. Examples of such materials include: compounds described in Japanese Patent Application Laid-Open Nos. 2000-47004, 2001-315242, 2001-31871 and 2001-296401.

A curable film prepared using a colloidal metal oxide obtained from the hydrolyzed condensate of metal alkoxide and a metal alkoxide composition is also preferred. Examples are described in Japanese Patent Application Laid-Open No. 2001-293818.

The refractive index of the high-refractive-index layer is generally 1.70 to 2.20. The thickness of the high-refractive-index layer is preferably 5 nm to 10 μm and more preferably 10 nm to 1 μm.

The refractive index of the intermediate-refractive-index layer is adjusted to a value between the refractive index of the low-refractive-index layer and that of the high-refractive-index layer. The refractive index of the intermediate-refractive-index layer is preferably 1.50 to 1.70.

(c-3) Low-Refractive-Index Layer

The low-refractive-index layer is formed on the high-refractive-index layer sequentially in the laminated manner. The refractive index of the low-refractive-index layer is 1.20 to 1.55 and preferably 1.30 to 1.50.

Preferably, the low-refractive-index layer is formed as the outermost layer having scratch resistance and stainproofing properties. As means of significantly improving scratch resistance, it is effective to provide the surface of the layer with slip properties, and conventionally known thin film forming means that includes introducing silicone or fluorine is used.

The refractive index of the fluorine-containing compound is preferably 1.35 to 1.50 and more preferably 1.36 to 1.47. The fluorine-containing compound is preferably a compound that includes a crosslinkable or polymerizable functional group containing fluorine atom in an amount of 35 to 80% by mass.

Examples of such compounds include: compounds described in Japanese Patent Application Laid-Open No. 9-222503, columns [0018] to [0026], Japanese Patent Application Laid-Open No. 11-38202, columns [0019] to [0030], Japanese Patent Application Laid-Open No. 2001-40284, columns [0027] to [0028], Japanese Patent Application Laid-Open No. 2000-284102, etc.

A silicone compound is preferably such that it has a polysiloxane structure, it includes a curable or polymerizable functional group in its polymer chain, and it has a crosslinking structure in the film. Examples of such silicone compounds include: reactive silicone (e.g. SILAPLANE manufactured by Chisso Corporation); and polysiloxane having a silanol group on each of its ends (one described in Japanese Patent Application Laid-Open No. 11-258403).

The crosslinking or polymerization reaction for preparing such fluorine-containing polymer and/or siloxane polymer containing a crosslinkable or polymerizable group is preferably carried out by radiation of light or by heating simultaneously with or after applying a coating composition for forming an outermost layer, which contains a polymerization initiator, a sensitizing agent, etc.

A sol-gel cured film is also preferable which is obtained by curing the above coating composition by the condensation reaction carried out between an organic metal compound, such as silane coupling agent, and silane coupling agent containing a specific fluorine-containing hydrocarbon group in the presence of a catalyst.

Examples of such films include: those of polyfluoroalkyl-group-containing silane compounds or the partially hydrolyzed and condensed compounds thereof (compounds described in Japanese Patent Application Laid-Open Nos. 58-142958, 58-147483, 58-147484, 9-157582 and 11-106704); and silyl compounds that contain “perfluoroalkyl ether” group as a fluoline-containing long-chain group (compounds described in Japanese Patent Application Laid-Open Nos. 2000-117902, 2001-48590 and 2002-53804).

The low-refractive-index layer can contain additives other than the above described ones, such as filler (e.g. low-refractive-index inorganic compounds whose primary particles have an average particle size of 1 to 150 nm, such as silicon dioxide (silica) and fluorine-containing particles (magnesium fluoride, calcium fluoride, barium fluoride); organic fine particles described in Japanese Patent Application Laid-Open No. 11-3820, columns [0020] to [0038]), silane coupling agent, slippering agent and surfactant.

When located under the outermost layer, the low-refractive-index layer may be formed by vapor phase method (vacuum evaporation, spattering, ion plating, plasma CVD, etc.). From the viewpoint of reducing manufacturing costs, coating method is preferable.

The thickness of the low-refractive-index layer is preferably 30 to 200 nm, more preferably 50 to 150 nm, and most preferably 60 to 120 nm.

(c-4) Hard Coat Layer

A hard coat layer is provided on the surface of both stretched and unstretched saturated norbornene resin films so as to impart physical strength to the antireflection film. Particularly preferably the hard coat layer is provided between the stretched transparent substrate and the above described high-refractive-index layer and between the unstretched transparent substrate and the above described high-refractive-index layer. It is also preferable to provide the hard coat layer directly on the stretched and unstretched saturated norbornene resin films by coating without providing an antireflection layer.

Preferably, the hard coat layer is formed by the crosslinking reaction or polymerization of compounds curable by light and/or heat. Preferred curable functional groups are photopolymerizable functional groups, and organic metal compounds having a hydrolytic functional group are preferably organic alkoxy silyl compounds.

Specific examples of such compounds include the same compounds as illustrated in the description of the high-refractive-index layer.

Specific examples of compositions that constitute the hard coat layer include: those described in Japanese Patent Application Laid-Open Nos. 2002-144913, 2000-9908 and WO 0/46617.

The high-refractive-index layer can also serve as a hard coat layer. In this case, it is preferable to form the hard coat layer using the technique described in the description of the high-refractive-index layer so that fine particles are contained in the hard coat layer in the dispersed state.

The hard coat layer can also serves as an anti-glare layer (described later), if particles having an average particle size of 0.2 to 10 μm are added to provide the layer with the anti-glare function.

The thickness of the hard coat layer can be properly designed depending on the applications for which it is used. The thickness of the hard coat layer is preferably 0.2 to 10 μm and more preferably 0.5 to 7 μm.

The strength of the hard coat layer is preferably H or higher, by pencil hardness test in accordance with JIS K5400, more preferably 2H or higher, and much more preferably 3H or higher. The hard coat layer having a smaller abrasion loss in test, before and after Taber abrasion test conducted in accordance with JIS K5400, is more preferable.

(c-5) Forward Scattering Layer

A forward scattering layer is provided so that it provides, when applied to liquid crystal displays, the effect of improving viewing angle when the angle of vision is tilted up-, down-, right- or leftward. The above described hard coat layer can also serve as a forward scattering layer, if fine particles with different refractive index are dispersed in it.

Example of such layers include: those described in Japanese Patent Application Laid-Open No. 11-38208 where the coefficient of forward scattering is specified; those described in Japanese Patent Application Laid-Open No. 2000-199809 where the relative refractive index of transparent resin and fine particles are allowed to fall in the specified range; and those described in Japanese Patent Application Laid-Open No. 2002-107512 wherein the haze value is specified to 40% or higher.

(c-6) Other Layers

Besides the above described layers, a primer layer, anti-static layer, undercoat layer or protective layer may be provided.

(c-7) Coating Method

The layers of the antireflection film can be formed by any method of dip coating, air knife coating, curtain coating, roller coating, wire bar coating, gravure coating, microgravure coating and extrusion coating (U.S. Pat. No. 2,681,294).

(c-8) Anti-Glare Function

The antireflection film may have the anti-glare function that scatters external light. The anti-glare function can be obtained by forming irregularities on the surface of the antireflection film. When the antireflection film has the anti-glare function, the haze of the antireflection film is preferably 3 to 30%, more preferably 5 to 20%, and most preferably 7 to 20%.

As a method for forming irregularities on the surface of antireflection film, any method can be employed, as long as it can maintain the surface geometry of the film. Such methods include: for example, a method in which fine particles are used in the low-refractive-index layer to form irregularities on the surface of the film (e.g. Japanese Patent Application Laid-Open No. 2000-271878); a method in which a small amount (0.1 to 50% by mass) of particles having a relatively large size (0.05 to 2 μm in particle size) are added to the layer under a low-refractive-index layer (high-refractive-index layer, intermediate-refractive-index layer or hard coat layer) to form a film having irregularities on the surface and a low-refractive-index layer is formed on the irregular surface while keeping the geometry (e.g. Japanese Patent Application Laid-Open Nos. 2000-281410, 2000-95893, 2001-100004, 2001-281407); a method in which irregularities are physically transferred on the surface of the outermost layer (stainproofing layer) having been provided (e.g. embossing described in Japanese Patent Application Laid-Open Nos. 63-278839, 11-183710, 2000-275401).

In the following the measurement methods used in the present invention will be described.

### (1) Dimensional Change Under Wet Heating (δL(W))

(i) A sample film is cut in the directions of MD and TD and conditioned in an atmosphere of 25° C. and 60% rh for 5 hours and more, and then measured for the length by use of a pin gauge of a 20 cm base length (wherein the measured values are referred to as MD(F) and TD(F), respectively).

(ii) The cut and conditioned samples are left standing with no tension in a temperature and humidity controlled oven at 60° C. and 90% rh for 500 hours (this treatment is referred to as “thermo-treatment”).

(iii) The samples after the “thermo treatment” are removed from the temperature and humidity controlled oven, conditioned in an atmosphere of 25° C. and 60% rh for 5 hours and more, and then measured for the length by use of a pin gauge of a 20 cm base length (wherein the measured values are referred to as MD(t) and TD(t), respectively).

(iv) The dimensional changes under wet heating (δMD(w)and δTD(w)) in the MD and the TD direction, respectively, are determined according to the following formulas, and a larger value thereof is referred to as the dimensional change under wet heating (δL(w)).

δTD(w)(%)=100×|TD(F)−TD(t)|/TD(F)

δMD(w)(%)=100×|MD(F)−MD(t)|/MD(F)

### (2) Dimensional Change Under Dry Heating (δL(D))

The dimensional change under dry heating (δL(d)) is determined in the same manner as described in the above dimensional change under wet heating (δL(w)) except that the “thermo-treatment” is changed to a dry atmosphere at 80° C. for 500 hours.

### (3) Re and Rth

A sample film, which is conditioned at 25° C. and 60% rh for 5 hours or more, is measured at the same temperature and humidity for retardation values by use of an automatic birefringence analyzer (KOBRA-21ADH: manufactured by Oji Scientific Instruments) to the light having a wavelength of 550 nm incident upon the surface of the film sample in the vertical direction thereof and in the direction ±40° inclined from the normal to the film plane. In-plane retardation (Re) is calculated from the measured value for the light in the vertical direction, and retardation in the thickness direction (Rth) is calculated from the measured value for the light in the direction ±40° inclined from the normal to the film plane. These are referred to as Re and Rth.

### (4) Change of Re and Rth Under Wet Heating

(i) A sample film is conditioned at 25° C. and 60% rh for 5 hours or more, and then measured for Re and Rth by the method as described above (wherein the measured values are referred to as Re(f) and Rth(f), respectively).

(ii) The sample is left standing with no tension in a temperature and humidity controlled oven at 60° C. and 90% rh for 500 hours (thermo treatment).

(iii) The sample after the thermo treatment is removed from the temperature and humidity controlled oven, conditioned in an atmosphere of 25° C. and 60% rh for 5 hours and more, and then measured for the Re and Rth in the manner as described above (wherein the measured values are referred to as Re(t) and Rth(t), respectively).

(iv) Change of Re and Rth under wet heating is determined by the following formulas.

Change of Re under wet heating(%)=100×(Re(f)−Re(t))/Re(f)

Change of Rth under wet heating(%)=100×(Rth(f)−Rth(t))/Rth(f)

### (5) Change of Re and Rth Under Dry Heating

The change of Re and Rth under dry heating is determined in the same manner as described in the above change of Re and Rth under wet heating except that the thermo-treatment is changed to a dry atmosphere at 80° C. for 500 hours.

### (6) Fine Retardation Unevenness

A sample film is conditioned in an atmosphere of 25° C. and 60% rh for 5 hours and more, and then is measured for Re at 10 points while being shifted by 0.1 mm in the MD direction by use of an ellipsometer (automatic birefringence evaluation system manufactured by UNIOPT Corporation, Ltd.).

The difference between the maximum value and the minimum value divided by the average value of the 10 points (fine retardation unevenness in the MD direction) is calculated. Fine retardation unevenness in the TD direction is also calculated by measuring the sample film while shifting it by 0.1 mm in the TD direction.

The larger one of the fine retardation unevenness in the MD direction and the fine retardation unevenness in the TD direction is defined as the fine retardation unevenness.

### (7) Length-to-Width Ratio

The length-to-width ratio is defined as a value (L/W) obtained by dividing the nip roll spacing used for stretching (L: the distance between the cores of two pairs of nip rolls) by the width of a saturated norbornene resin film before stretching (W). When there are three pairs of nip rolls or more, a larger L/W value is defined as the length-to-width ratio.

### (8) The Percentage of Relaxation

The percentage of relaxation is defined as a value obtained by dividing the relaxation length by the dimension of a film before stretching and expressing the result in percentage.

In the following specific embodiments of the saturated norbornene film of the present invention will be described. It is to be understood that the present invention is not intended to be limited to these embodiments.

### EXAMPLES

### 1. Saturated Norbornene Resin

### (1) Saturated Norbornene Resin-A

To 6-methyl-1,4,5,8-dimethano-1,4,4a,5,6,7,8,8a-octahydronaphthalene, 10 parts of 15% solution of triethyl aluminum in cyclohexane as a polymerization catalyst, 5 parts of triethylamine, and 10 parts of 20% solution of titanium tetrachloride in cyclohexane were added to induce ring opening polymerization in cyclohexane, and the polymer resulting from the ring opening polymerization was hydrogenated in the presence of nickel catalyst to obtain a polymer solution. The polymer solution was solidified in isopropyl alcohol and dried to obtain a powdered resin. The number average molecular weight, hydrogenation rate and Tg of the obtained resin were 40,000, 99.8% or higher and 139° C., respectively.

### (2) Saturated Norbornene Resin-B

100 parts of 8-methyl-8-methoxycarbonyltetracyclo[4.4.0.12.5,17.10]-3-dodecene (specific monomer B), 150 parts of 5-(4-biphenylcarbonyloxy)bicyclo [2.2.1]hept-2-ene (specific monomer A), 18 parts of 1-hexene (molecular weight modifier), and 750 parts of toluene were fed into a reactor where the atmosphere was replaced with nitrogen, and the solution was heated to 60° C. Then, to the solution in the reactor, 0.62 parts of solution of triethyl aluminum (1.5 mol/l) in toluene as a polymerization catalyst and 3.7 parts of solution of t-butanol and methanol-modified tungsten hexachloride (t-butanol:methanol:tungsten=0.35 mol:0.3 mol:1 mol) in toluene (concentration 0.05 mol/l) were added, and the system was heated and stirred at 80° C. for 3 hours to induce ring opening polymerization to obtain a solution of polymer resulting from the ring opening polymerization. The degree of conversion in the polymerization reaction was 97%, and the intrinsic viscosity (η inh) of the polymer resulting from the ring opening polymerization measured in chloroform at 30° C. was 0.65 dl/g.

4,000 parts of solution of the polymer resulting from the ring opening polymerization thus obtained was fed into an autoclave, and 0.48 parts of RuHCL(CO)[P(C₆H₅)₃]₃ was added to the solution and heated and stirred for 3 hours at a hydrogen gas pressure of 100 kg/cm², a reaction temperature of 165° C. to induce hydrogenation reaction. The resultant reaction solution (solution of the hydrogenated polymer) was cooled, and the hydrogen pressure was relieved. This reaction solution was poured into a large amount of methanol to separate and recover the solidified matter, and the solidified matter was dried to obtain a hydrogenated polymer (specific cyclic polyolefin resin). The hydrogenation rate of the olefinic unsaturated bond of the resultant hydrogenated polymer measured with 400 MHz, 1H-NMR was 99.9%. The Tg of the resultant polymer was 110° C., the number average molecular weight (Mn) and weight average molecular weight (Mw), in terms of polystyrene, of the same measured by GPC (solvent: tetrahydrofuran) were 39,000 and 126,000, respectively, and the molecular weight distribution (Mw/Mn) was 3.23.

### 2. Film Formation

### (1) Melt Film Formation

Fine particles of silicon dioxide described in Table 1 were added to the above described saturated norbornene resin-A to form column-shaped pellets 3 mm in diameter and 5 mm in length. These pellets were dried in a vacuum drier at 110° C. so that their water content became 0.1% or lower and fed into a hopper whose temperature had been adjusted to Tg−10° C. The same process was performed using, instead of fine particles of silicon dioxide, those of titanium dioxide, aluminum oxide, zirconium oxide, calcium carbonate, talc or clay.

The melt temperature was adjusted so that the melt viscosity of the resin mixture became 5000 Pa·s. And the resin mixture was melted with a single-screw kneader at this temperature over 5-minute period and cast from a T-die whose temperature had been set so as to be higher than the melt temperature by 10° C. onto a casting drum whose temperature had been set to Tg−5° C., so that the resin mixture was solidified to take the form of a film. In this operation, each-level static electricity application method (a 10 kV wire was installed in the position 10 cm away from the point on the casting drum at which the melt was landed) was employed. The solidified melt was stripped and wound up. Just before carrying out the wind-up operation, the both side ends (3% of the entire width for each) of the film underwent trimming and the both side ends of the trimmed film underwent knurling 10 mm in width and 50 μm in height. 3000 m of film for each level was wound up with its width kept 1.5 m and at a wind-up rate of 30 m/min.

### (2) Solution Film Formation

The above described saturated norbornene resin-B and fine particles of silicon dioxide described in Table 1 were introduced into toluene under stirring so that the concentration of the mixture in toluene was 30%. The same process was performed using, instead of fine particles of silicon dioxide, those of titanium dioxide, aluminum oxide, zirconium oxide, calcium carbonate, talc or clay.

Stirring was stopped when the introduction of the resin and fine particles was completed, and the mixture was allowed to swell at 25° C. for 3 hours to prepare a slurry. The slurry was stirred again to completely dissolve the mixture in toluene (This solution is referred as dope. The viscosity of the solution was 30,000 mPa·s at room temperature.). The solution was filtered through filter paper with an absolute filtration rating of 0.01 mm (manufactured by Toyo Roshi Kaisha, LTD, #63) and further filtered through filter paper with an absolute filtration rating of 2.5 μm (manufactured by PALL Corporation, FH025).

The above described dope was warmed to 35° C. and cast on a mirror stainless substrate with a band length of 60 m whose temperature had been set to 25° C. The gieser used was one having a shape similar to the gieser described in Japanese Patent Laid-Open No. 11-314233. The cast speed was 60 m/min and the cast width was 250 cm.

The film was stripped off while keeping the amount of the residual solvent 100% by weight, dried at 130° C., and wound up when the amount of the residual solvent was as shown in Table 2 to obtain a saturated norbornene film. 3 cm from both side ends of the obtained film underwent trimming and the portions 2 to 10 mm from both side ends of the trimmed film underwent knurling 100 μm in height. 3000 m of the resultant film was wound up into a roll.

### 3. Stretching

### (i) Longitudinal (MD) Stretching

The saturated norbornene resin films obtained from the melt film-forming and solution film-forming as described above (all containing a residual solvent of 0.1% by weight or less) were longitudinally stretched at Tg+15° C. by use of two pairs of nip rolls.

### (ii) Transverse (TD) Stretching

The longitudinally stretched films were stretched transversely at Tg+10° C. by use of a tenter at the magnification as illustrated in Table 1.

### 4. Heat Treatment

Subsequently, the stretched films were subjected to a heat treatment process under the heat treatment conditions (heat treatment temperature, conveyance tension during heat treatment, and heat treatment time) as illustrated in Table 1.

### 5. Evaluation of Stretched Film

The thus obtained stretched films were measured for dimensional change under wet heating (δL(w)), dimensional change under dry heating (δL(d)), Re and Rth before wet heating or dry heating treatment (fresh), fine retardation unevenness, change of Re and Rth under wet heating (δRe(w), δRth(w)), and change of Re and Rth under dry heating (δRe(d), δRth(d)) according to the methods as described above, and the results were summarized in Table 1.

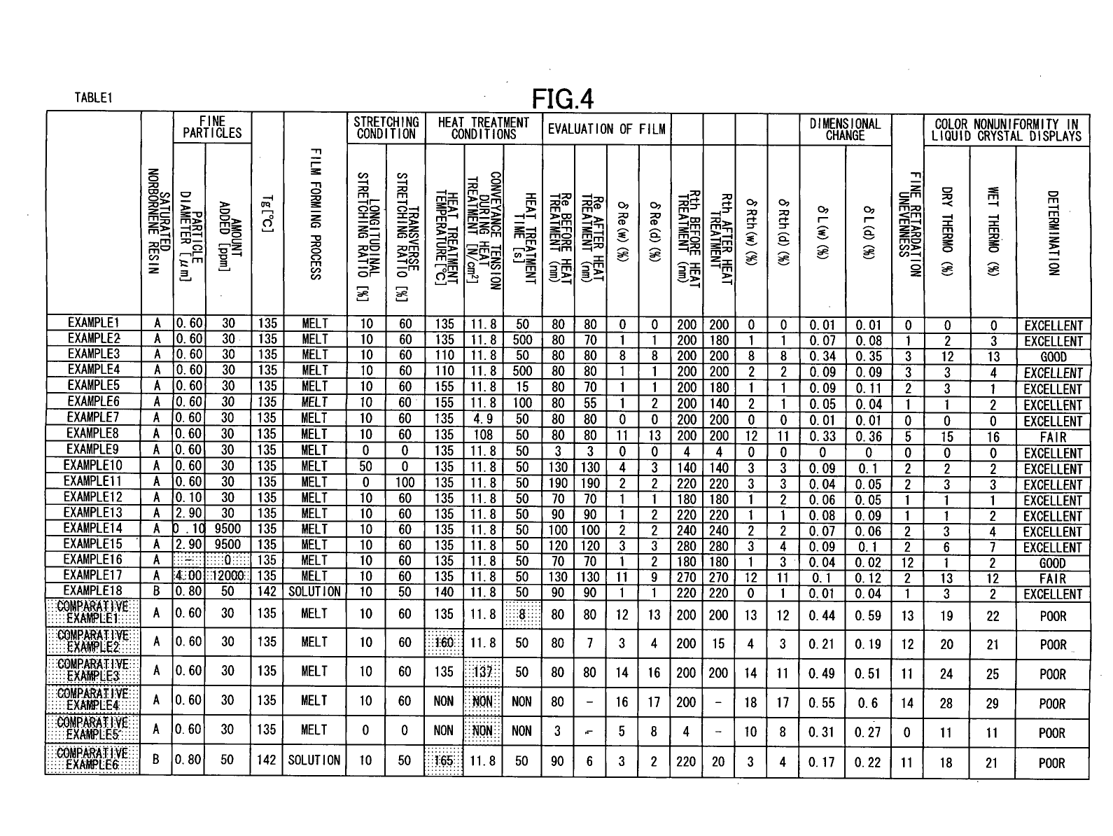

In Examples 1 to 8 and Comparative Examples 1 to 4 shown in Table 1 of FIG. 4, stretched saturated norbornene resin films were produced by melt film forming method using the same saturated norbornene resin (the above described saturated norbornene resin-A) and 30 ppm of fine particles having an average particle size of 0.60 μm added to the saturated norbornene resin. The evaluations shown in Table 1 indicate that in the films of Example 1 to 8, which were produced under the conditions that satisfy the conditions of the present invention: tension of 2 N/cm² or higher and 120 N/cm² or lower; temperature of (Tg−30° C.) or higher and (Tg+20° C.) or lower; and treatment time of 10 seconds or longer and 600 seconds or shorter, the changes under wet heating (δL(w), δRe(w), δRth(w)) and changes by dry heating (δL(d), δRe(d), δRth(d)) were smaller than those in the films of Comparative Examples 1 to 4 (though heat treatment was not done for the film of Comparative Example 4) and particularly fine retardation unevenness was smaller. Similarly, for the unstretched films, in the film of Example 9, which was heat treated under the conditions of the present invention, the changes by wet heat and changes by dry heat were smaller than those in the film of Comparative Example 5, which was not heat treated. The evaluations also indicate that the results were good even in the films of Examples 9 to 11 (though the film of Example 9 was unstretched film), which were produced under different stretching condition.

In Example 12 to 17, stretched saturated norbornene resin films were produced varying the particle size of and the amount of the fine particles to be added to the above described saturate norbornene resin-A. In the film of Example 16, fine Re non-uniformity was larger than that of the films of other examples, because no fine particles were added. In the film of Example 17, the changes by wet heat and changes by dry heat tended to be a little large, because the average particle size of the fine particles added was outside the range of 0.1 μm to 3.0 μm and the amount of the same added also exceeded the range of 1 ppm to 10000 ppm. However, the evaluations of the films of examples were good as a whole.

In Example 18 and Comparative Example 6 shown in Table 1 of FIG. 4, stretched saturated norbornene resin films were produced by solution film forming method using the same saturated norbornene resin (the above described saturated norbornene resin-B). The evaluations shown in Table 1 indicate that in the stretched saturated norbornene resin film produced by solution film forming method, if it was produced under the conditions that satisfy the conditions of the present invention: tension of 2 N/cm² to 120 N/cm²; temperature of (Tg−30° C.) to (Tg+20° C.); and treatment time of 10 seconds to 600 seconds, the changes under wet heating (δL(w), δRe(w), δRth(w)) and changes by dry heating (δL(d), δRe(d), δRth(d)) were smaller and fine retardation unevenness was smaller than those in the film of Comparative Example 6 (the condition of heat treatment of (Tg+20° C.) or lower (in this resin, 162° C. or lower).

### 6. Preparation of Polarizing Plate

### (1) Surface Treatment

The surface of the film at each and every level underwent corona discharge treatment so that its contact angle to the surface of water is 45 degrees.

### (2) Preparation of Polarizing Layer

A polarizing layer of 20 μm thick was prepared by stretching a film in the longitudinal direction by a difference in peripheral speed between two pairs of nip rolls according to Example 1 of Japanese Patent Laid-Open No. 2001-141926. A polarizing layer was similarly prepared in which a film was stretched so that the stretching axis is inclined by 45 degree as described in Example 1 of Japanese Patent Laid-Open No. 2002-86554. The evaluation result obtained was similar to the above described one.

### (3) Adhesion

The polarizing layer thus obtained was inserted between the above described saponified stretched saturated norbornene film (retardation plate) and a saponified protective film for polarizing plate (trade name: Fujitack). The adhesion between the retardation plate and the polarizing layer was performed using as an adhesive 3% aqueous solution of PVA (PVA-117H manufactured by Kuraray Co., Ltd.), when the retardation plate was made of saturated norbornene resin, or an epoxy adhesive, when the retardation plate was made of a material other than cellulose acylate. The adhesion between Fujitack and the polarizing layer was performed using as an adhesive the above described PVA aqueous solution. The adhesion was performed in such a manner that the angle between the polarization axis and the length of the retardation plate became 45 degrees.

The thus obtained fresh polarizing plates and the polarizing plates after wet thermo-treatment (60° C. and 90% rh for 500 hours) or dry thermo-treatment (dry atmosphere of 80° C. for 500 hours) were each mounted on a 20 inch VA-type liquid crystal display device illustrated in FIGS. 2 to 9 in Japanese Patent Laid-Open No. 2000-154261 so that the saturated norbornene film is at the liquid crystal side. The liquid crystal display devices using the polarizing plates subjected to dry thermo-treatment or wet thermo-treatment were compared by visual evaluation with those using the fresh polarizing plates, respectively, and the percentage of the region where color nonuniformity are generated in the total area was illustrated in Table 1.

As apparent from Table 1 of FIG. 4, those polarizing plates in which the present invention has been embodied provided good performance.

### 7. Preparation of Optical Compensation Film

The cellulose acetate film, on which the liquid crystal layer in Example 1 of Japanese Patent Laid-Open No. 11-316378 is coated, was replaced by the stretched saturated norbornene resin film of the present invention. At this time, the cases where there were used the stretched films after wet thermo-treatment (60° C. and 90% rh for 500 hours) or dry thermo-treatment (dry atmosphere of 80° C. for 500 hours) were compared, by visual evaluation of the region where color nonuniformity are generated, with the cases where there were used those immediately after film-forming and stretching (fresh films), respectively. It was possible to produce good optical compensation films by using the stretched saturated norbornene resin films of the present invention.

The cellulose acetate film, on which the liquid crystal layer in Example 1 of Japanese Patent Laid-Open No. 7-333433 is coated, was replaced by the stretched saturated norbornene resin film of the present invention to prepare an optical compensation filter film. In this case also, it was possible to produce good optical compensation films.

### 8. Preparation of Low Reflection Film

The stretched saturated norbornene resin film of the present invention was used to prepare a low reflection film according to Example 47 in the Journal of Technical Disclosure published by the Japan Institute of Invention and Innovation (Technical Disclosure No. 2001-1745). The film provided good optical performance.

### 9. Preparation of Liquid Crystal Display Element

The polarizing plate of the present invention as described above was used for the liquid crystal display device described in Example 1 of Japanese Patent Laid-Open No. 10-48420, the optical anisotropy layer containing a discotic liquid crystal molecule described in Example 1 of Japanese Patent Laid-Open No. 9-26572, an oriented film coated with polyvinyl alcohol, the 20 inch VA-type liquid crystal display device illustrated in FIGS. 2 to 9 of Japanese Patent Laid-Open No. 2000-154261, the 20 inch OCB-type liquid crystal display device illustrated in FIGS. 10 to 15 of Japanese Patent Laid-Open No. 2000-154261, and the IPS-type liquid crystal display device illustrated in FIG. 11 of Japanese Patent Laid-Open No. 2004-12731. Further, the low reflection film of the present invention was adhered to the outermost surface of these liquid crystal displays and the displays were evaluated for their color nonuniformity. The resultant liquid crystal display devices were so good that they were free from color nonuniformity even after being exposed to high temperature and high humidity over time.

1-15. (canceled)

16. A method for producing a thermoplastic resin film, comprising a step of
heat treating a thermoplastic resin film at a temperature of Tg−30° C. to Tg+20° C., Tg representing the glass transition temperature of the thermoplastic resin, for 10 seconds to 600 seconds while conveying the thermoplastic resin film at a tension of 2 N/cm2 to 120 N/cm2.

17. The method for producing a thermoplastic resin film according to claim 16, wherein the thermoplastic resin film has a dimensional change under wet heating (SL(w)) and a dimensional change by dry heating (SL(d)) of 0% to 0.3% each.

18. The method for producing a thermoplastic resin film according to claim 16, wherein the thermoplastic resin film has a change of in-plane retardation (Re) under wet heating (SRe(w)) of 0% to 10%, a change of in-plane retardation (Re) by dry heating (SRe(d)) of 0% to 10%, a change of retardation in the thickness direction (Rth) under wet heating (SRth(w)) of 0% to 10% and a change of retardation (Rth) in the thickness direction by dry heating (SRth(d)) of 0% to 10%.

19. The method for producing a thermoplastic resin film according to claim 17, wherein the thermoplastic resin film has a change of in-plane retardation (Re) under wet heating (SRe(w)) of 0% to 10%, a change of in-plane retardation (Re) by dry heating (SRe(d)) of 0% to 10%, a change of retardation in the thickness direction (Rth) under wet heating (SRth(w)) of 0% to 10% and a change of retardation (Rth) in the thickness direction by dry heating (SRth(d)) of 0% to 10%.

20. The method for producing a thermoplastic resin film according to claim 16, wherein the thermoplastic resin film has an orientation angle of 0°±5° or 90°±5°, a bowing distortion of 10% or lower, an in-plane retardation (Re) of 0 nm to 500 nm, and a retardation in the thickness direction (Rth) of 0 nm to 500 rim.

21. The method for producing a thermoplastic resin film according to claim 19, wherein the thermoplastic resin film has an orientation angle of 0°±5° or 90°±5°, a bowing distortion of 10% or lower, an in-plane retardation (Re) of 0 nm to 500 nm, and a retardation in the thickness direction (Rth) of 0 rim to 500 nm.

22. The method for producing a thermoplastic resin film according to claim 16, wherein the thermoplastic resin film has a fine retardation unevenness of 0% to 10%.

23. The method for producing a thermoplastic resin film according to claim 21, wherein the thermoplastic resin film has a fine retardation unevenness of 0% to 10%.

24. The method for producing a thermoplastic resin film according to claim 16, wherein the thermoplastic resin is a saturated norbornene resin.

25. The method for producing a thermoplastic resin film according to claim 23, wherein the thermoplastic resin is a saturated norbornene resin.

26. The method for producing a thermoplastic resin film according to claim 24, wherein the thermoplastic resin film contains 1 ppm to 10000 ppm of fine particles having an average particle size of 0.1 μm to 3.0 μm.

27. The method for producing a thermoplastic resin film according to claim 25, wherein the thermoplastic resin film contains 1 ppm to 10000 ppm of fine particles having an average particle size of 0.1 pm to 3.0 μm.

28. The method for producing a thermoplastic resin film according to claim 16, wherein the heat treatment is conducted for an unstretched thermoplastic resin film.

29. The method for producing a thermoplastic resin film according to claim 27, wherein the heat treatment is conducted for an unstretched thermoplastic resin film.

30. The method for producing a thermoplastic resin film according to claim 16, wherein the heat treatment is conducted for a stretched thermoplastic resin film.

31. The method for producing a thermoplastic resin film according to claim 27, wherein the heat treatment is conducted for a stretched thermoplastic resin film.
